(19) United States
(12) Patent Application Publication
(10) Pub. No.: US 2024/0186538 A1
(43) Pub. Date: Jun. 6, 2024

(54) ELECTROCHEMICAL DEVICE

(71) Applicants: EKPO FUEL CELL TECHNOLOGIES GMBH, Dettingen (DE); MARQUARDT GMBH, Rietheim-Weilheim (DE)

(72) Inventors: Lukas Haas, Reutlingen (DE); Florian Class, Dettingen an der Erms (DE); Wolfgang Fritz, Metzingen (DE); Kathrin Kullen, Hülben (DE); Arni Antal, Bad Urach (DE); Joachim Seitz, Kirchheim (DE); Bernd Hugger, Villingen-Schwenningen (DE); Peter Broghammer, Wurmlingen (DE)

(21) Appl. No.: 18/443,046

(22) Filed: Feb. 15, 2024

Related U.S. Application Data
(63) Continuation of application No. PCT/EP2022/071340, filed on Jul. 29, 2022.

(30) Foreign Application Priority Data
Aug. 17, 2021 (DE) 10 2021 121 359.2

(51) Int. Cl. H01M 8/0247; H01M 8/04537; H01M 8/2465

(52) U.S. Cl. CPC H01M 8/0247; H01M 8/2465; H01M 8/04559

(57) ABSTRACT

In order to provide an electrochemical device, comprising a stack of electrochemical units that succeed one another in a stack direction, wherein each electrochemical unit comprises a bipolar plate, and a terminal connector that comprises an electrically insulating housing and a plurality of electrically conductive contact elements, wherein the stack of electrochemical units of the electrochemical device is configured to make safe, reliable and robust electrical contact for continuous measurement of the electrical potentials of the bipolar plates of the stack, it is proposed that a plurality of the bipolar plates each comprise a terminal element that projects in a contact-making direction, beyond lateral edges of the bipolar plate adjacent to the terminal element, wherein the terminal element has at least one latching element with which the terminal connector is latchable, and/or has at least one contact-making bead with which, in a mounted condition of the terminal connector, one of the contact elements of the terminal connector is engageable, in order to make an electrically conductive contact between the bipolar plate and the respectively associated contact element of the terminal connector.

### RELATED APPLICATIONS

This application is a continuation of international application number PCT/EP2022/071340 filed on 29 Jul. 2022 and claims the benefit of German application number 10 2021 121 359.2 filed on Aug. 17, 2021.

The present disclosure relates to the subject matter disclosed in international application number PCT/EP2022/071340 of 29 Jul. 2022 and German application number 10 2021 121 359.2 of 17 Aug. 2021, which are incorporated herein by reference in their entirety and for all purposes.

### FIELD OF THE DISCLOSURE

The present invention relates to an electrochemical device, which comprises a stack of electrochemical units that succeed one another in a stack direction, wherein each electrochemical unit comprises a bipolar plate, and which comprises a terminal connector that comprises an electrically insulating housing and a plurality of electrically conductive contact elements.

The electrochemical units may in particular take the form of fuel cell units, for example PEM (polymer-electrolyte membrane) fuel cell units.

For monitoring and control of the operation of an electrochemical device of this kind, it is necessary to be able to continuously measure the electrical potentials or cell voltages at the bipolar plates of the stack during operation of the electrochemical device.

A challenge here is to compensate both the manufacturing tolerances at the time of manufacturing the stack of electrochemical units, and also relative movements of the bipolar plates of the stack during operation of the electrochemical device.

The object of the present invention is to provide an electrochemical device of the type mentioned in the introduction, of which the stack of electrochemical units is configured to make safe, reliable and robust electrical contact for continuous measurement of the electrical potentials of the bipolar plates of the stack.

### SUMMARY OF THE INVENTION

According to the invention, this object is achieved in the case of an electrochemical device according to the precharacterising clause of claim 1 in that a plurality of the bipolar plates each comprise a terminal element that projects in a contact-making direction, beyond lateral edges of the bipolar plate adjacent to the terminal element,

wherein the terminal element has at least one latching element with which the terminal connector is latchable, and/or has at least one contact-making bead with which, in a mounted condition of the terminal connector, one of the contact elements of the terminal connector is engageable, in order to make an electrically conductive contact between the bipolar plate and the respectively associated contact element of the terminal connector.

In this arrangement, the contact elements of the terminal connector are preferably configured to be resiliently deformable, in order to enable manufacturing tolerances of the stack of electrochemical units to be compensated in that each contact element is elastically biased towards a latching element or towards a contact-making bead of a terminal element associated with the respective contact element, of a bipolar plate of the stack.

Further, as a result of the resilience of the contact elements, relative movements of the bipolar plates of the stack during operation of the electrochemical device containing the stack of electrochemical units are also compensated.

The terminal element may take the form of a tapping tab.

The at least one latching element may for example take the form of a latching bead.

The term “bead” in this description and in the attached claims is understood to mean a structure that is produced in a layer-like starting material by a shaping procedure and forms a raised portion, for example in the form of a rib, on one side of the shaped layer and a recess, for example in the form of a groove, of a complementary shape to the raised portion, on the opposite side of the shaped layer.

In the case of the electrochemical device according to the invention, a latching element taking the form of a latching bead may at the same time take on the function of a contact-making bead.

Conversely, a contact-making bead formed on the terminal element may at the same time take on the function of a latching element taking the form of a latching bead.

In a preferred embodiment of the invention, it is provided for the at least one contact element to have at least two contact-making arms which, in the mounted condition of the terminal connector, abut against the terminal element.

The contact-making arms may abut for example against a planar contact zone or a contact bead of the terminal element.

In this context, it may for example be provided, in the mounted condition of the terminal connector, for the two contact-making arms to abut against two mutually remote sides of the terminal element.

As an alternative thereto, it may also be provided, in the mounted condition of the terminal connector, for the two contact-making arms to abut against the same side of the terminal element.

In order to keep the terminal connector securely in its position mounted on the stack of electrochemical units, a latching mechanism by which the terminal connector is latchable to at least one terminal element of a bipolar plate of the stack of electrochemical units may be provided.

For example, it may be provided for the at least one contact element to have at least one latching arm that, in the mounted condition of the terminal connector, engages behind a latching element of the terminal element.

In a particular embodiment of the invention, it is provided for the at least one contact element to have at least two latching arms that, in the mounted condition of the terminal connector, abut against two mutually remote sides of the terminal element.

In this context, it may be provided for one of the latching arms to have a greater length than the other latching arm.

Fundamentally, however, it could also be provided for both latching arms to have substantially the same length.

In a preferred embodiment of the invention, it is provided for the at least two contact-making arms to abut against a first side of the terminal element and for the at least one latching arm to abut against a second side of the terminal element that is remote from the first side of the terminal element.

In this context, it may be provided for the at least one latching arm of the contact element to be arranged, as seen in a direction running parallel to the stack direction, between two contact-making arms of the contact element.

It is in particular favourable if the at least one latching arm is arranged, as seen in the direction running parallel to the stack direction, centrally between two contact-making arms of the contact element.

Each contact element may comprise a base part from which at least one contact-making arm and/or at least one latching arm of the contact element project.

The at least one contact-making arm and/or the at least one latching arm may take a form that is in one piece with the base part of the contact element.

The entire contact element may be made in one piece or may be formed from a plurality of separate parts, for example two or more.

In a particular embodiment of the invention, it is provided for the contact element to have at least two latching arms, wherein, in the mounted condition of the terminal connector, in each case a latching arm and a contact-making arm are arranged in pairs, one above the other in the stack direction.

Further, it may be provided for the terminal connector to comprise at least one latching element which, in the mounted condition of the terminal connector, engages behind a latching projection of the terminal element.

In this context, the latching projection preferably projects from a lateral edge of the terminal element, in a direction of projection that runs parallel to a front edge of the terminal element.

The lateral edge of the terminal element may extend substantially parallel to the contact-making direction of the terminal element.

A latching element of this kind may take the form for example of a latching hook.

A latching element of this kind may be fixed to a housing of the terminal connector or take a form in one piece with a housing part of the terminal connector.

Further, it may be provided, for the purpose of latching the terminal connector to at least one terminal element of a bipolar plate of the stack of electrochemical units, for the terminal connector to comprise at least one latching element which, in the mounted condition of the terminal connector, is latched into a latching recess in the terminal element.

A latching recess of this kind may in particular take the form of a latching passage opening that extends completely through the bipolar plate in the region of the terminal element.

In this case too, the latching element may take the form for example of a latching hook.

In a particular embodiment, it is further provided for the terminal connector to comprise at least one deflection recess and at least one immobilising element, wherein using this, in the mounted condition of the terminal connector, a region of the terminal element is displaceable into the deflection recess associated with the immobilising element.

In this way, a positively-locking connection is made between the terminal element and the housing of the terminal connector and prevents the terminal connector from moving away from the at least one terminal element of a bipolar plate of the stack of electrochemical units.

The at least one immobilising element may be pushable into the housing of the terminal connector in a direction that is substantially parallel to a longitudinal extent of a latching element and/or a longitudinal direction of a contact-making bead of the immobilising element.

In a particular embodiment of the invention, it is provided for the terminal connector to comprise at least one latching element which, in the mounted condition of the terminal connector, engages behind a latching bead formed on the terminal element, or a latching notch.

A latching bead and/or latching notch of this kind may be arranged offset in relation to the at least one contact-making bead of the terminal element, in a direction of offset running parallel to a front edge of the terminal element.

Preferably, a latching bead of this kind extends in a longitudinal direction that is oriented perpendicular to a longitudinal direction in which a contact-making bead of the terminal element extends, and/or perpendicular to the stack direction of the stack of electrochemical units.

Preferably, the latching bead of the terminal element is latchable to the latching element of the terminal connector.

As an alternative or in addition to a latching bead, it may be provided for the terminal element to have at least one latching notch that is arranged offset in relation to the at least one contact-making bead, in a direction of offset running parallel to a front edge of the terminal element, and behind which a latching element of the terminal connector is engageable.

Preferably, a latching notch of this kind extends in a longitudinal direction that is oriented parallel to a longitudinal direction in which a contact-making bead of the terminal element extends, and/or perpendicular to the stack direction of the stack of electrochemical units.

Preferably, the latching notch of the terminal element is latchable to the latching element of the terminal connector.

In a preferred embodiment of the invention, it is provided for the terminal connector to comprise at least two rows of contact elements, each of which, in the mounted condition of the terminal connector, extend in the stack direction and are offset from one another perpendicular to the stack direction.

In this context, it may be provided, in the mounted condition of the terminal connector, for each row of contact elements to make electrically conductive contact with every nth one of the bipolar plates that succeed one another in the stack direction, where n is greater than or equal to 2.

In a preferred embodiment of the stack according to the invention of electrochemical units, it is provided for the stack to comprise at least two rows of terminal elements of the bipolar plates, each of which extend in the stack direction and are offset from one another perpendicular to the stack direction, wherein the terminal elements of bipolar plates that directly succeed one another in the stack direction are associated with different rows of terminal elements, in order in this way to increase the spacing between each two terminal elements that succeed one another in the stack direction in a row of this kind.

Such an offset of the terminal elements of bipolar plates that directly succeed one another in the stack direction may be achieved for example in that the bipolar plates that directly succeed one another in the stack direction take a substantially identical form to one another but are offset from one another by an angle of 180° about an axis of rotation parallel to the stack direction.

In this way, the height tolerances in the stack of electrochemical units, and the setting behaviour of the stack over its service life may be compensated even if the cell pitch, that is to say the offset of bipolar plates that directly succeed one another in the stack direction, is very small in the stack direction, for example less than 1.5 mm.

In a preferred embodiment of the stack of electrochemical units, it is provided for each of the bipolar plates to be formed in multiple layers.

For example, it may be provided for each bipolar plate to comprise at least a first bipolar plate layer and a second bipolar plate layer.

In this arrangement, a latching element and/or a contact-making bead may be formed in only the first bipolar plate layer or only the second bipolar plate layer.

The respectively other bipolar plate layer, in which no latching element or contact-making bead is formed, may take a substantially planar form in its region opposite the latching element or the contact bead of the respectively other bipolar plate layer.

As an alternative thereto, it may be provided for a first latching element and/or a first contact-making bead to be formed in the first bipolar plate layer and a second latching element and/or a second contact-making bead to be formed in the second bipolar plate layer.

The first latching element and the second latching element may take a form substantially mirror-symmetrical to one another in respect of a centre plane of the bipolar plate that runs perpendicular to the stack direction.

As an alternative thereto, it may be provided for the first latching element and the second latching element to be formed asymmetrically to one another in respect of mirror symmetry along a centre plane of the bipolar plate that runs perpendicular to the stack direction.

If the first latching element takes the form of a first latching bead and the second latching element takes the form of a second latching bead, the latching bead may have a first rising flank remote from a main body of the bipolar plate, and the second latching bead may have a second rising flank remote from the main body of the bipolar plate, wherein the first rising flank is inclined in relation to the stack direction by an angle α that is smaller than an angle α′ by which the second rising flank is inclined in relation to the stack direction.

Further, it may be provided for at least one latching bead to have a rising flank remote from a main body of the bipolar plate and a falling flank facing the main body of the bipolar plate, wherein the rising flank is inclined in relation to the stack direction by an angle α that is greater than an angle β by which the falling flank is inclined in relation to the stack direction.

As a result, the falling flank of the latching bead takes a steeper form than the rising flank, which has the effect that the contact element associated with the bipolar plate can easily be pushed onto the latching bead by way of the gently rising flank.

The greater steepness of the falling flank has the effect that the space needed on the terminal element of the bipolar plate for the formation of the latching bead is kept small.

Further, a steep falling flank on the latching bead is advantageous if the contact element has a latching element on the contact element side that engages behind the latching bead, since in this way it becomes more difficult to unintentionally unlatch a latching element of this kind on the contact element side from the latching bead.

The first contact-making bead and the second contact-making bead may take a form substantially mirror-symmetrical to one another in respect of a centre plane of the bipolar plate that runs perpendicular to the stack direction.

As an alternative thereto, it may be provided for the first contact-making bead and the second contact-making bead to be formed asymmetrically to one another in respect of mirror symmetry along a centre plane of the bipolar plate that runs perpendicular to the stack direction.

As a result, the first contact-making bead may have a first rising flank remote from a main body of the bipolar plate, and the second contact-making bead may have a second rising flank remote from the main body of the bipolar plate, wherein the first rising flank is inclined in relation to the stack direction by an angle α that is smaller than an angle α′ by which the second rising flank is inclined in relation to the stack direction.

Further, it may be provided for at least one contact-making bead to have a rising flank remote from a main body of the bipolar plate and a falling flank facing the main body of the bipolar plate, wherein the rising flank is inclined in relation to the stack direction by an angle α that is greater than an angle β by which the falling flank is inclined in relation to the stack direction.

As a result, the falling flank of the contact-making bead takes a steeper form than the rising flank, which has the effect that the contact element associated with the bipolar plate can easily be pushed onto the contact-making bead by way of the gently rising flank.

The greater steepness of the falling flank has the effect that the space needed on the terminal element of the bipolar plate for the formation of the contact-making bead is kept small.

Further, a steep falling flank on the contact-making bead is advantageous if the contact element has a latching element on the contact element side that engages behind the contact-making bead, since in this way it becomes more difficult to unintentionally unlatch a latching element of this kind on the contact element side.

In a particular embodiment of the stack of electrochemical units, it is provided for the terminal element to have at least one stop bead, which is arranged on the side of a latching element, or a contact-making bead, of the terminal element, facing a main body of the bipolar plate.

A stop bead of this kind may limit the distance over which a latching element which is on the contact element side and is arranged on the contact element can be pushed onto the terminal element of the bipolar plate.

This ensures that, in the mounted condition of the terminal connector, positioning of the terminal connector in the contact-making direction relative to the terminal element of the bipolar plate is as exact as possible.

If the bipolar plate comprises at least a first bipolar plate layer and a second bipolar plate layer, it may be provided for a first stop bead to be formed in the first bipolar plate layer and a second stop bead to be formed in the second bipolar plate layer.

As an alternative thereto, it may be provided for the bipolar plate to comprise a first bipolar plate layer and a second bipolar plate layer, wherein a first stop bead is formed in the first bipolar plate layer and a recess is formed in the second bipolar plate layer, wherein the recess in the second bipolar plate layer engages with the first stop bead of the first bipolar plate layer.

This has the effect of mechanically reinforcing the profiling of the terminal element of the bipolar plate that is formed by the first stop bead and the recess. Moreover, the latching depth may be increased in a manner that has no effect on overall size.

Preferably, it is provided for the recess in the second bipolar plate layer to have a shape substantially complementary to the first stop bead of the first bipolar plate layer.

In order to keep the terminal connector securely in its position mounted on the stack of electrochemical units, a latching mechanism may be provided, using which the terminal connector is latchable to at least one terminal element of a bipolar plate of the stack of electrochemical units.

For example, it may be provided for the terminal element to have at least one latching bead and/or at least one latching notch, which is arranged offset in relation to the at least one contact-making bead in a direction of offset running parallel to a front edge of the terminal element, and behind which a latching element of the terminal connector is engageable.

Preferably, a latching bead of this kind extends in a longitudinal direction that is oriented perpendicular to a longitudinal direction in which a contact-making bead of the terminal element extends, and/or perpendicular to the stack direction of the stack of electrochemical units.

Preferably, the latching bead of the terminal element is latchable to the latching element of the terminal connector.

As an alternative or in addition to a latching bead, it may be provided for the terminal element to have at least one latching notch that is arranged offset in relation to the at least one contact-making bead, in a direction of offset running parallel to a front edge of the terminal element, and behind which a latching element of the terminal connector is engageable.

Preferably, a latching notch of this kind extends in a longitudinal direction that is oriented parallel to a longitudinal direction in which a contact-making bead of the terminal element extends, and/or perpendicular to the stack direction of the stack of electrochemical units.

Preferably, the latching notch of the terminal element is latchable to the latching element of the terminal connector.

Further, it may be provided for the terminal element to have a latching notch, which extends in a longitudinal direction that runs parallel to a front edge of the terminal element and behind which a latching element of the terminal connector is engageable.

Preferably, such a latching notch of the terminal element is latchable to a contact element of the terminal connector.

Further, it may be provided for the terminal element to comprise a latching projection, wherein the latching projection projects from a lateral edge of the terminal element, in a along a direction of projection that runs parallel to a front edge of the terminal element.

The lateral edge may extend substantially parallel to the contact-making direction of the terminal element.

A latching projection of this kind is preferably configured for a latching element of the terminal connector to engage behind.

A latching element of this kind may for example take the form of a latching hook.

A latching element of this kind may be fixed to a housing of the terminal connector or take a form in one piece with a housing part of the terminal connector.

Further, it may be provided, for the purpose of latching the terminal connector to at least one terminal element of a bipolar plate of the stack of electrochemical units, for the terminal element to have at least one latching recess.

A latching recess of this kind may in particular take the form of a latching passage opening that extends completely through the bipolar plate in the region of the terminal element.

Preferably, a latching element of the terminal connector is latchable into a latching recess of this kind.

In a particular embodiment of the stack of electrochemical units, it is further provided for the terminal element to have a region which, for the purpose of immobilising the terminal connector on the terminal element by an immobilising element of the terminal connector, is displaceable into a deflection recess in a housing of the terminal connector.

In this way, a positively-locking connection is made between the terminal element and the housing of the terminal connector and prevents the terminal connector from moving away from the at least one terminal element of a bipolar plate of the stack of electrochemical units.

The at least one latching element of the terminal element may take the form of a latching bead or a latching notch.

A latching notch of this kind preferably extends substantially parallel to a front edge of the terminal element that, in the mounted condition of the electrochemical device, faces the terminal connector.

Preferably, the latching notch comprises a bend line, by which the latching notch is connected in one piece to a region of the terminal element that adjoins the latching notch, and a plurality of free edges, for example three free edges, along which the latching notch has been severed from the region of the terminal element that adjoins the latching notch.

Severing may have been performed for example by a stamping procedure or a cutting procedure, for example a laser cutting procedure.

The bend line preferably forms a delimitation, facing the terminal connector in the mounted condition of the electrochemical device, of the latching notch.

The terminal element is preferably formed with at least two layers and comprises a first terminal element part and a second terminal element part that are connected to one another in a substance-to-substance bond.

The first terminal element part and the second terminal element part may be connected to one another, for example by welding, preferably by laser welding.

The first terminal element part and the second terminal element part are preferably connected to one another in a substance-to-substance bond in a region of the terminal element that, in the mounted condition of the electrochemical device, does not make contact with a contact element of the terminal connector.

Further, it may be provided for a front edge of the first terminal element part, which in the mounted condition of the electrochemical device faces the terminal connector, to be offset in the contact-making direction in relation to a front edge of the second terminal element part. As a result of this offsetting of the front edges of the terminal element parts on the end face of the terminal element that, in the mounted condition of the electrochemical device, faces the terminal connector, mounting the terminal connector on the stack of electrochemical units is made easier.

Because the terminal element parts of the terminal element are connected to one another in a substance-to-substance bond, the mechanical stability of the terminal element is enhanced, in particular as regards distortion. This is in particular important if the bipolar plate layers are of low thickness and are made from a comparatively soft material, in particular since the terminal element has to have a relatively large extent in the contact-making direction in order to compensate manufacturing tolerances of the stack and to ensure the required overlap of the terminal element with the respectively associated contact element of the terminal connector.

In a preferred embodiment of the invention, the material thickness of the bipolar plate layers is in each case at most 200 μm, in particular at most 100 μm.

The effect of the terminal element being stabilised by the substance-to-substance bond between the terminal element parts is that the electrically conductive contact between the terminal connector and the terminal elements of the stack is not broken, even under the action of shock forces and vibrations.

Further, deformation of the terminal elements as a result of high forces, which may occur when the terminal connector is mounted on the stack of electrochemical units, is prevented.

Preferably, by exceeding an unlatching force, the terminal connector is unlatchable from the at least one latching element of the terminal element in order for example to be able to carry out maintenance or repair.

Further features and advantages of the invention form the subject matter of the description below, and the illustration in the drawings of exemplary embodiments.

### BRIEF DESCRIPTION OF THE DRAWINGS

FIG. 1 shows a perspective illustration of an electrochemical device that comprises a stack (illustrated highly schematically) of electrochemical units that succeed one another in a stack direction and each comprise a bipolar plate, and a terminal connector that comprises an electrically insulating housing and a plurality of electrically conductive contact elements, wherein each of the bipolar plates comprises a respective terminal element that takes the form of a terminal lug and projects in a contact-making direction, beyond lateral edges of the respective bipolar plate adjacent to the respective terminal element, and wherein the respective terminal element has at least one bead that serves as a latching bead and with which a respectively associated contact element of the terminal connector is latchable, and serves as a contact-making bead with which, in a mounted condition of the terminal connector, the respectively associated contact element of the terminal connector is engageable, in order to make an electrically conductive contact between the respective bipolar plate and the respectively associated contact element of the terminal connector, as seen in the direction of view of a rear side of the terminal connector that is remote from the stack of electrochemical units;

FIG. 2 shows a further perspective illustration of the electrochemical device from FIG. 1, as seen in the direction of view of an underside of the terminal connector, in which contact-making arms of contact elements of the terminal connector are visible;

FIG. 3 shows a plan view, from above, of the electrochemical device from FIGS. 1 and 2, as seen in the direction of view of an upper side of the terminal connector, in which latching arms of contact elements of the terminal connector are visible;

FIG. 4 shows a cross section through a detail of the electrochemical device from FIGS. 1 to 3, along the line 4-4 in FIG. 3;

FIG. 5 shows a cross section through a detail of the electrochemical device from FIGS. 1 to 4, along the line 5-5 in FIG. 3;

FIG. 6 shows a plan view, from below, of the electrochemical device from FIGS. 1 to 5, as seen in the direction of view of an underside of the terminal connector, in which contact-making arms of contact elements of the terminal connector are visible;

FIG. 7 shows a side view of the electrochemical device from FIGS. 1 to 6, as seen in the direction of view of a right-hand side of the terminal connector, in the direction of the arrow 7 in FIG. 3;

FIG. 8 shows a side view of the electrochemical device from FIGS. 1 to 7, as seen in the direction of view of a left-hand side of the terminal connector, in the direction of the arrow 8 in FIG. 3;

FIG. 9 shows a side view of the electrochemical device from FIGS. 1 to 8, as seen in the direction of view of a rear side of the terminal connector, in the direction of the arrow 9 in FIG. 3;

FIG. 10 shows a (highly schematic) perspective illustration of the stack of electrochemical units of the electrochemical device from FIGS. 1 to 9, in which the terminal elements of the bipolar plates are visible, wherein these are arranged in two rows that each extend in the stack direction of the stack of electrochemical units and are offset from one another in a direction of offset that is oriented perpendicular to the stack direction, wherein the terminal elements of bipolar plates that directly succeed one another in the stack direction are associated with different rows of terminal elements, in order to increase the spacing between each two terminal elements that succeed one another in the stack direction in a row of this kind;

FIG. 11 shows a perspective illustration of a bipolar plate of the stack of electrochemical units from FIG. 10, as seen in the direction of view of an upper side of the bipolar plate;

FIG. 12 shows a further perspective illustration of the bipolar plate from FIG. 11, as seen in the direction of view of an underside of the bipolar plate;

FIG. 13 shows a plan view, from above, of the bipolar plate from FIGS. 11 and 12;

FIG. 14 shows an enlarged illustration of the region I from FIG. 13;

FIG. 15 shows a cross section through a detail of the bipolar plate from FIGS. 11 to 14 in the region of a latching and contact-making bead of the terminal element, along the line 15-15 in FIG. 14;

FIG. 16 shows a side view of a detail of the bipolar plate from FIGS. 11 to 15, as seen in the direction of view of the arrow 16 in FIG. 14;

FIG. 17 shows a front view of a detail of the bipolar plate from FIGS. 11 to 16, as seen in the direction of view of the contact-making direction, in the direction of the arrow 17 in FIG. 14;

FIG. 18 shows a plan view, from below, of a detail of the bipolar plate from FIGS. 11 to 17, as seen in the direction of view of the arrow 18 in FIG. 16;

FIG. 19 shows a perspective illustration of the terminal connector of the electrochemical device from FIGS. 1 to 9, as seen in the direction of view of a front side of the terminal connector onto which contact element receptacles of the terminal connector open;

FIG. 20 shows a further perspective illustration of the terminal connector from FIG. 19, as seen in the direction of view of an underside of the terminal connector, in which contact-making arms of contact elements of the terminal connector are visible;

FIG. 21 shows a further perspective illustration of the terminal connector of the electrochemical device from FIGS. 19 and 20, as seen in the direction of view of a rear side of the terminal connector;

FIG. 22 shows a plan view, from above, of the terminal connector from FIGS. 19 to 21, as seen in the direction of view of an upper side of the terminal connector, in which latching arms of contact elements of the terminal connector are visible;

FIG. 23 shows a plan view, from below, of the terminal connector from FIGS. 19 to 22, as seen in the direction of view of an underside of the terminal connector, in which contact-making arms of contact elements of the terminal connector are visible;

FIG. 24 shows a side view of the terminal connector from FIGS. 19 to 23, as seen in the direction of view of a left-hand side of the terminal connector, in the direction of the arrow 24 in FIG. 22;

FIG. 25 shows a side view of the terminal connector from FIGS. 19 to 24, as seen in the direction of view of a right-hand side of the terminal connector, in the direction of the arrow 25 in FIG. 22;

FIG. 26 shows a front view of the terminal connector from FIGS. 19 to 25, as seen in the direction of view of the arrow 26 in FIG. 22;

FIG. 27 shows a cross section through the terminal connector from FIGS. 19 to 26 in the region of latching arms of contact elements of the terminal connector, along the line 27-27 in FIG. 26;

FIG. 28 shows a cross section through the terminal connector from FIGS. 19 to 27 in the region of contact-making arms of contact elements of the terminal connector, along the line 28-28 in FIG. 26;

FIG. 29 shows a view of the terminal connector from FIGS. 19 to 28 from behind, as seen in the direction of view of a rear side of the terminal connector, in the direction of the arrow 29 in FIG. 22;

FIG. 30 shows a perspective illustration of a rear part of the terminal connector from FIGS. 19 to 29, with the contact elements of the terminal connector arranged on this rear part;

FIG. 31 shows a perspective illustration of one of the contact elements of the terminal connector from FIGS. 19 to 30, as seen in the direction of view of an underside of a latching arm and an underside of two contact-making arms of the contact element;

FIG. 32 shows a further perspective illustration of the contact element from FIG. 31, as seen in the direction of view of an upper side of the latching arm and an upper side of the contact-making arms of the contact element;

FIG. 33 shows a plan view of the contact element from FIGS. 31 and 32, from below;

FIG. 34 shows a side view of the contact element from FIGS. 31 to 33, as seen in the direction of view of the arrow 34 in FIG. 33;

FIG. 35 shows a front view of the contact element from FIGS. 31 to 34, as seen in the direction of view of the arrow 35 in FIG. 33;

FIG. 36 shows a rear view of the contact element from FIGS. 31 to 35, as seen in the direction of view of the arrow 36 in FIG. 33;

FIG. 37 shows a schematic plan view, from above, of a bipolar plate with a terminal element;

FIG. 38 shows an enlarged illustration of the region II from FIG. 37;

FIG. 39 shows a front view of the terminal element of the bipolar plate from FIG. 38, as seen in the direction of view of the arrow 39 in FIG. 38;

FIG. 40 shows a plan view, from above, of an upper part of a contact element that has a long latching arm and a short contact-making arm;

FIG. 41 shows a plan view, from above, of a lower part of a contact element that has a short contact-making arm and a long latching arm;

FIG. 42 shows a plan view of the terminal element of a bipolar plate which is in engagement with a contact element of the type illustrated in FIGS. 40 and 41;

FIG. 43 shows a cross section through a detail of the terminal element of the bipolar plate and the contact element of the terminal connector from FIG. 42, along the line 43-43 in FIG. 42, wherein the terminal element of the bipolar plate is formed symmetrically in relation to a centre plane of the bipolar plate that is oriented perpendicular to the stack direction of the stack of electrochemical units;

FIG. 44 shows a cross section, corresponding to FIG. 43, through a detail of the terminal element of the bipolar plate and the contact element of the terminal connector, wherein the terminal element is not formed to be mirror-symmetrical in relation to a centre plane of the bipolar plate that is oriented perpendicular to the stack direction of the stack of electrochemical units;

FIG. 45 shows a schematic plan view of a terminal element of a bipolar plate which has a contact-making bead that is in engagement with a contact element of a terminal connector, wherein the terminal connector comprises a latching element that, in the mounted condition of the terminal connector, engages behind a latching projection of the terminal element of the bipolar plate;

FIG. 46 shows a schematic longitudinal section through the terminal element of the bipolar plate and through the contact element and the latching element of the terminal connector in FIG. 45, along the line 46-46 in FIG. 45;

FIG. 47 shows a schematic plan view of the terminal element of a bipolar plate which has a contact-making bead that is in engagement with a contact element of the terminal connector, and further has latching recesses into each of which a latching element of the terminal connector is latched;

FIG. 48 shows a schematic longitudinal section through the terminal element which has the contact-making bead and the latching recesses, and through the contact element of the terminal connector and the latching elements of the terminal connector from FIG. 47, along the line 48-48 in FIG. 47;

FIG. 49 shows a schematic plan view of the terminal element of a bipolar plate which has a contact-making bead that is in engagement with a contact element of a terminal connector, wherein a housing of the terminal connector further comprises a plurality of deflection recesses and a corresponding number of immobilising elements using which, in the mounted condition of the terminal connector, a respective region of a terminal element is displaceable into the deflection recess that is respectively associated with the respective immobilising element, in a condition before the terminal connector is immobilised on the terminal elements of the bipolar plates;

FIG. 50 shows a side view of a plurality of terminal elements of bipolar plates, which succeed one another in the stack direction of the stack of electrochemical units, and of regions of the housing of the terminal connector in which deflection recesses are made, as seen in the direction of view of the arrow 50 in FIG. 49, in a condition before the terminal connector is immobilised on the terminal elements of the bipolar plates;

FIG. 51 shows a schematic plan view, corresponding to FIG. 49, of the terminal element of a bipolar plate, a contact element of the terminal connector, and an immobilising element of the terminal connector, in a condition after immobilisation of the terminal connector on the terminal elements of the bipolar plates, wherein the immobilising element has been pushed into the housing of the terminal connector in a direction parallel to a longitudinal extent of the contact-making bead of the terminal element, as a result of which a region of the terminal element has been driven into a deflection recess in the terminal connector which is associated with the immobilising element concerned;

FIG. 52 shows a schematic side view, corresponding to FIG. 50, of the terminal elements of two bipolar plates that succeed one another in the stack direction of the stack of electrochemical units, and of the regions of the housing of the terminal connector in which the deflection recesses are made, in the condition in which the terminal connector has been immobilised on the terminal elements of the bipolar plates, after the immobilising elements have been pushed into the housing of the terminal connector in the direction parallel to the longitudinal extent of the contact-making beads, as a result of which regions of the terminal elements have been driven into the same respectively adjacent deflection recesses;

FIG. 53 shows a schematic plan view of a terminal element of a bipolar plate which has a contact-making bead that is in engagement with a contact element of the terminal connector, wherein the terminal connector further comprises a latching element that, in the mounted condition of the terminal connector, engages behind a latching bead formed on the terminal element;

FIG. 54 shows a schematic longitudinal section through the contact-making bead and the latching bead of the terminal element of the bipolar plate, through the contact element of the terminal connector, and through the latching element of the terminal connector from FIG. 53, along the line 54-54 in FIG. 53;

FIG. 55 shows a schematic longitudinal section through the latching bead of the terminal element of the bipolar plate and through the latching element of the terminal connector from FIG. 53, along the line 55-55 in FIG. 53;

FIG. 56 shows a schematic plan view of a terminal element of a bipolar plate which has a contact-making bead that is in engagement with a contact element of the terminal connector, wherein the terminal connector further comprises a latching element that, in the mounted condition of the terminal connector, engages behind a latching notch formed on the terminal element;

FIG. 57 shows a schematic longitudinal section through the contact-making bead and the latching notch of the terminal element of the bipolar plate, through the contact element of the terminal connector, and through the latching element of the terminal connector from FIG. 56, along the line 57-57 in FIG. 56;

FIG. 58 shows a schematic cross section through the latching notch of the terminal element of the bipolar plate and through the latching element of the terminal connector from FIG. 56, along the line 58-58 in FIG. 56; and

FIG. 59 shows a perspective illustration of a latching element of a terminal element of a bipolar plate, which takes the form of a latching notch, wherein the latching notch extends substantially parallel to a front edge of the terminal element that, in the mounted condition of the terminal connector, faces the terminal connector.

### DETAILED DESCRIPTION OF THE INVENTION

Like or functionally equivalent elements are designated by the same reference numerals in all the Figures.

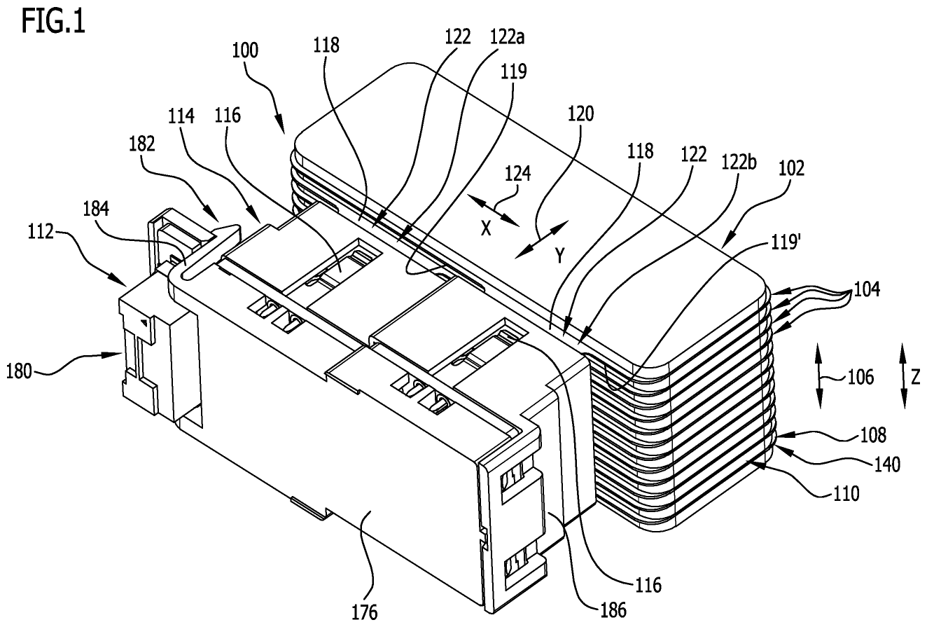

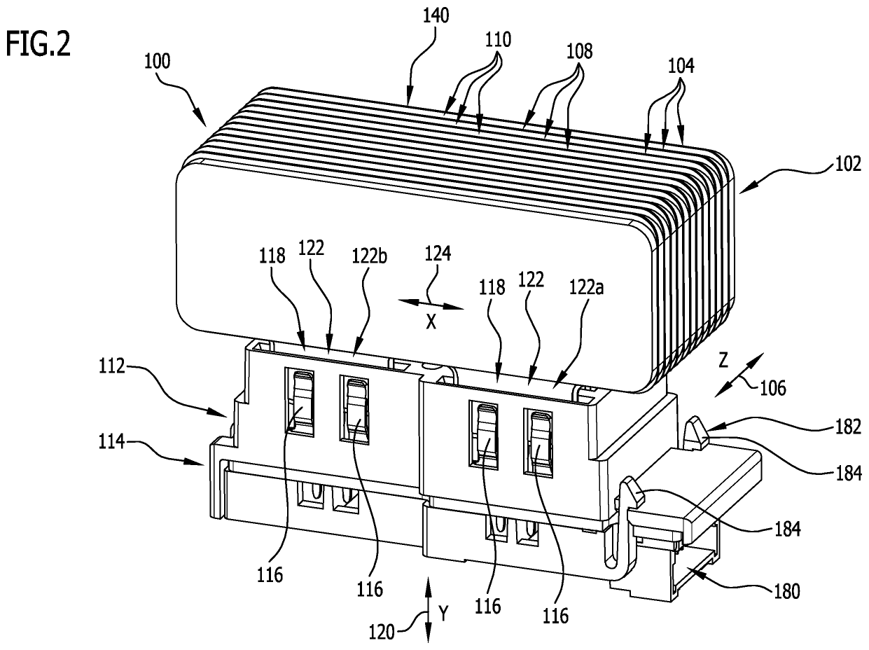

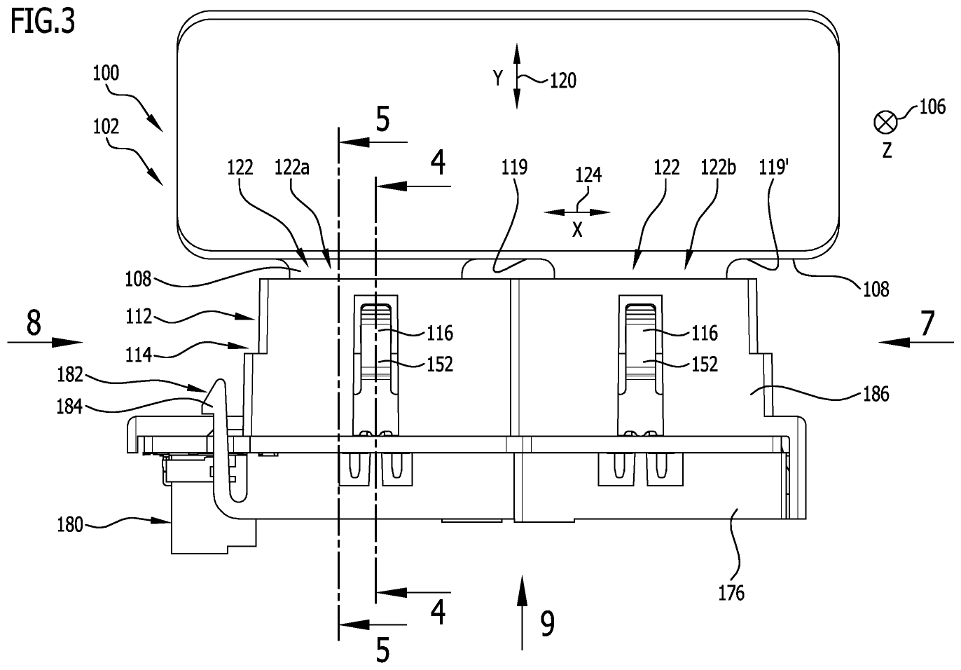

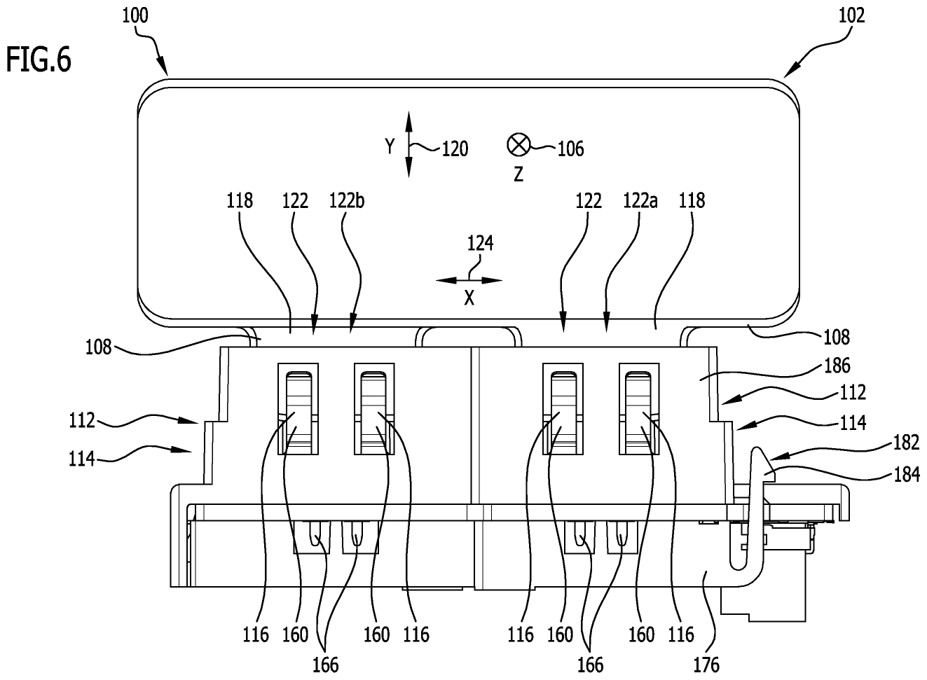

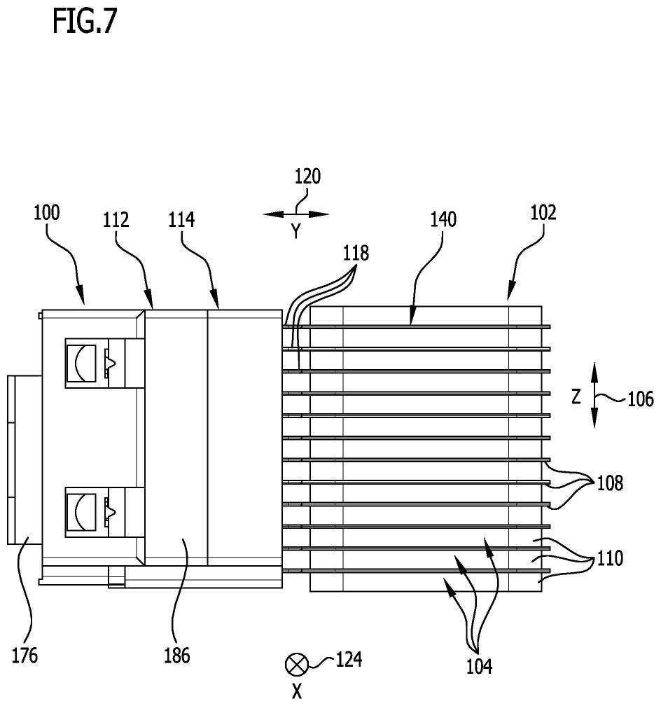

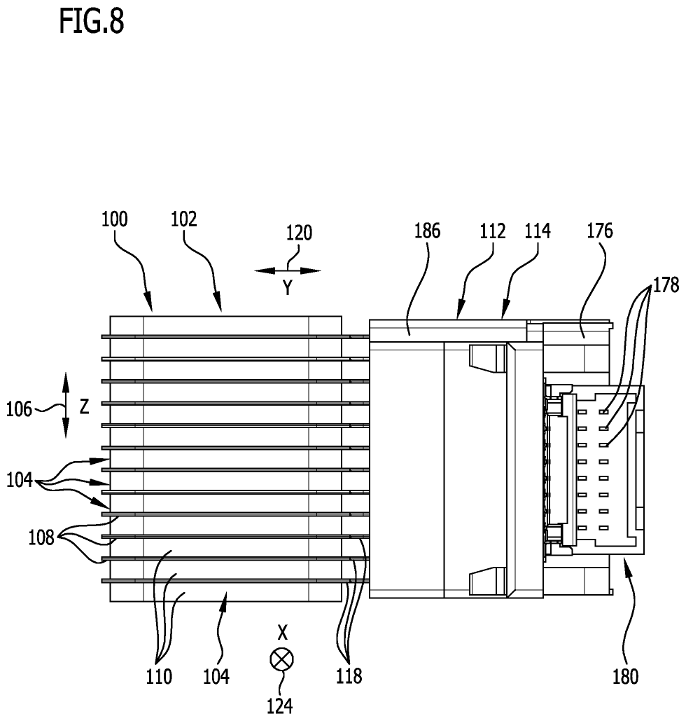

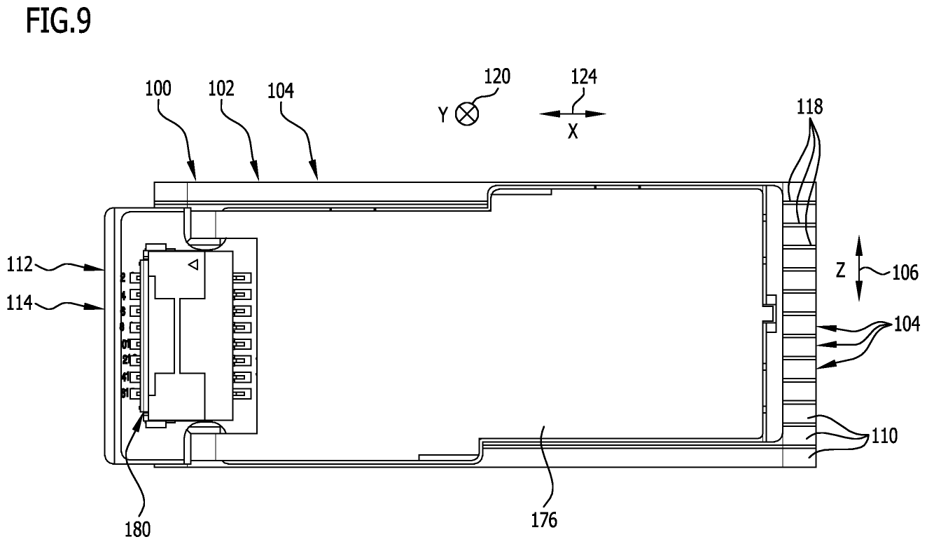

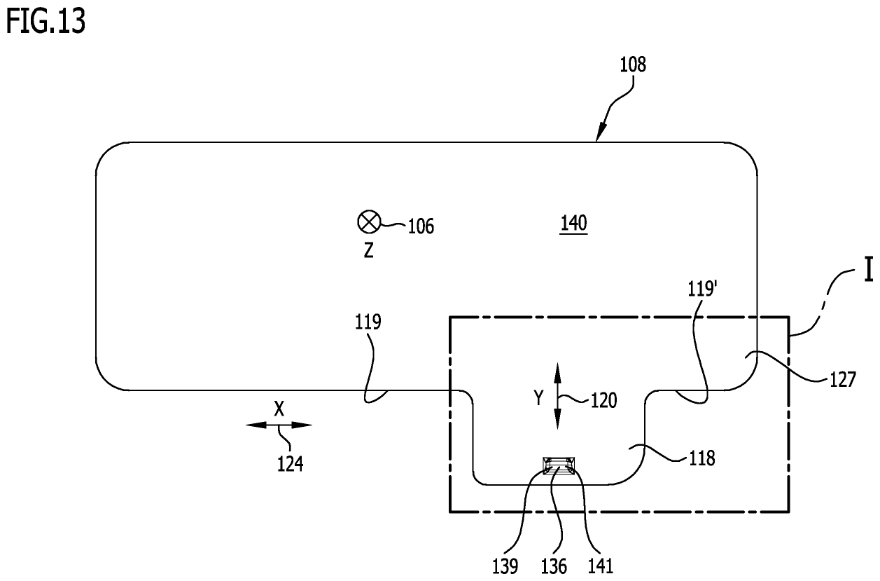

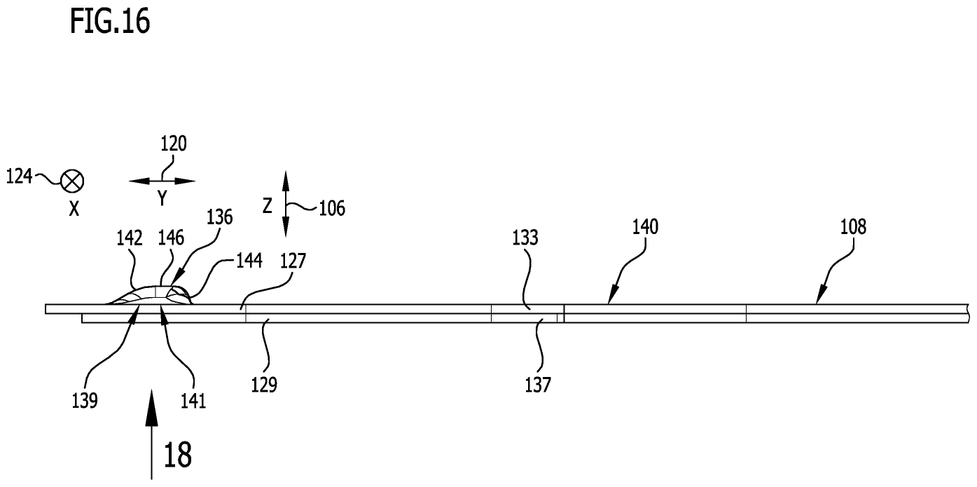

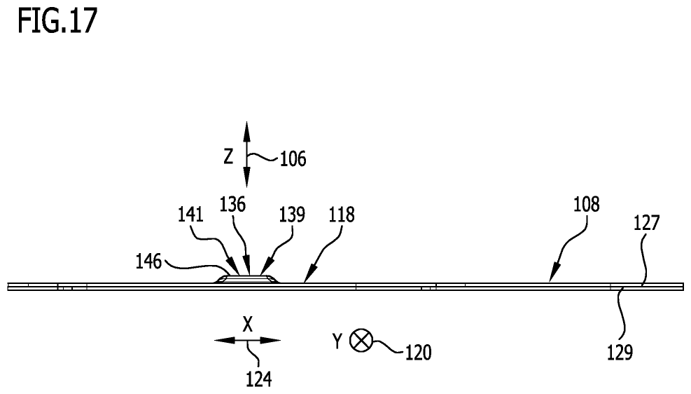

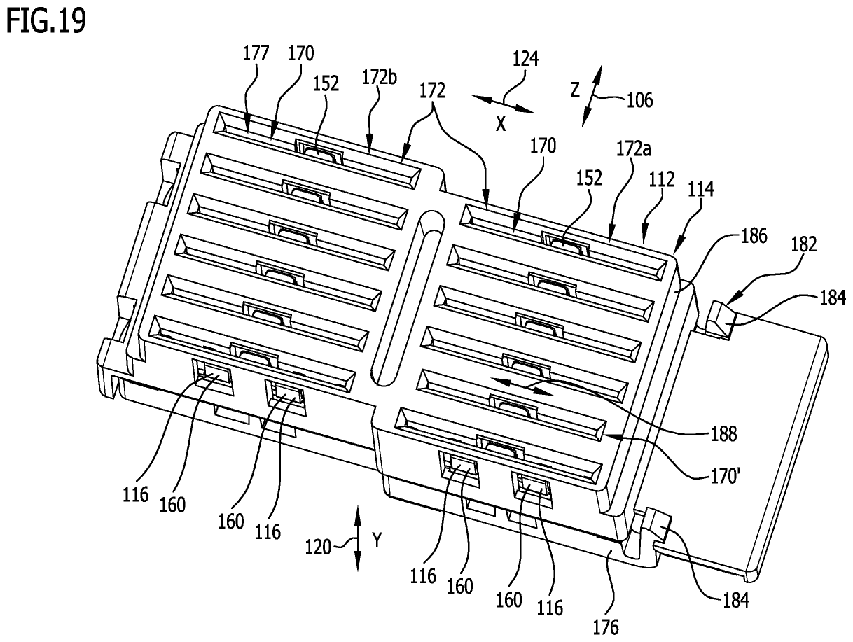

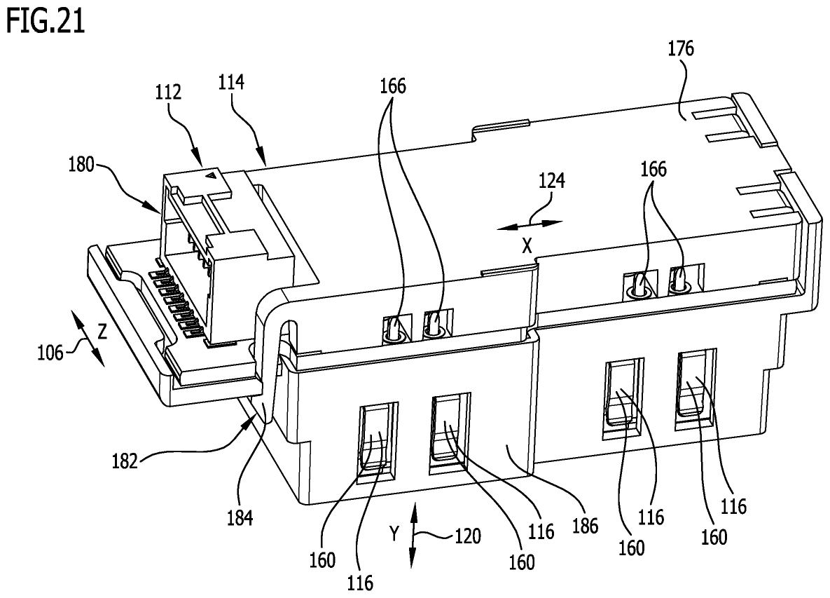

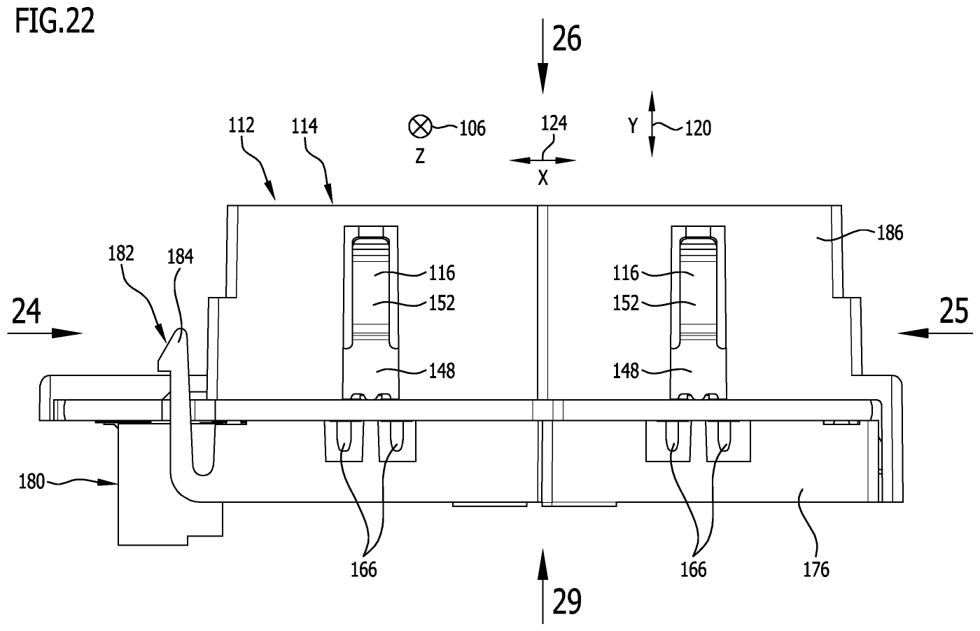

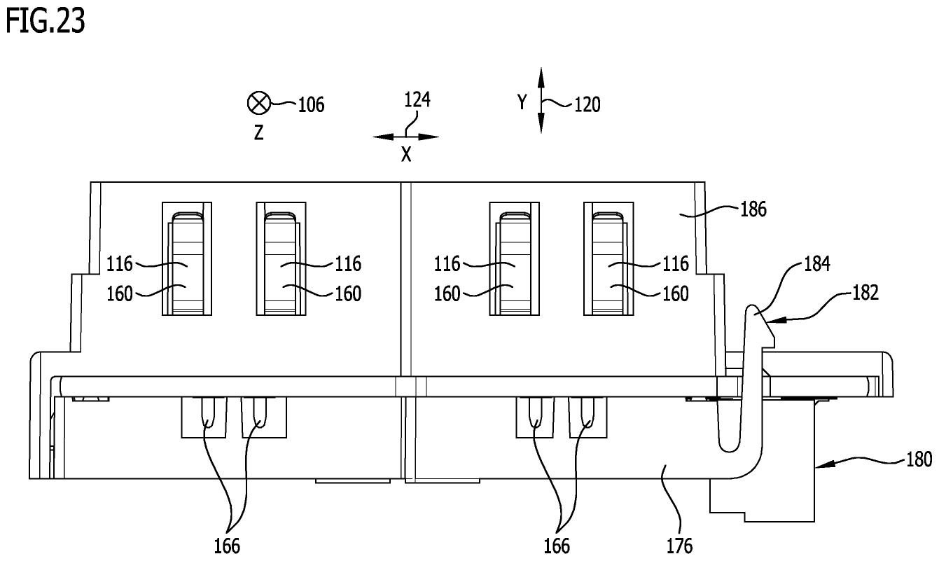

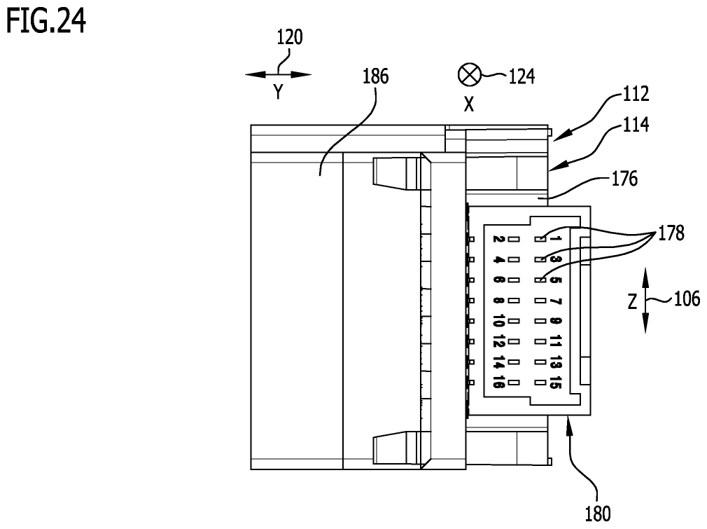

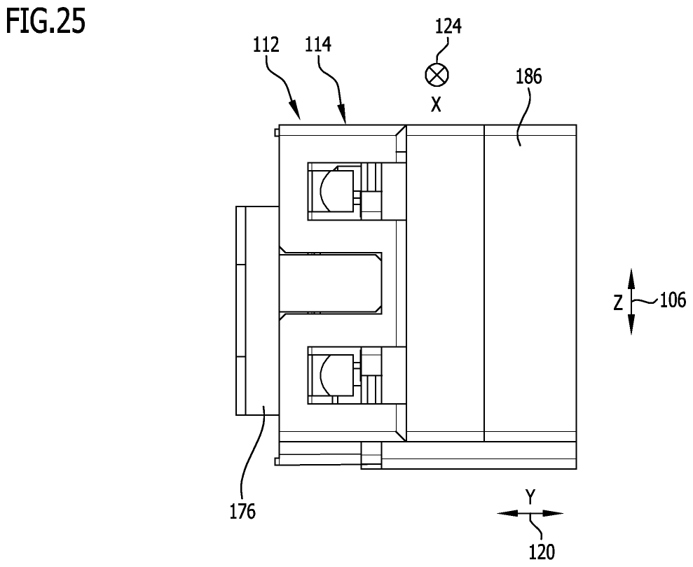

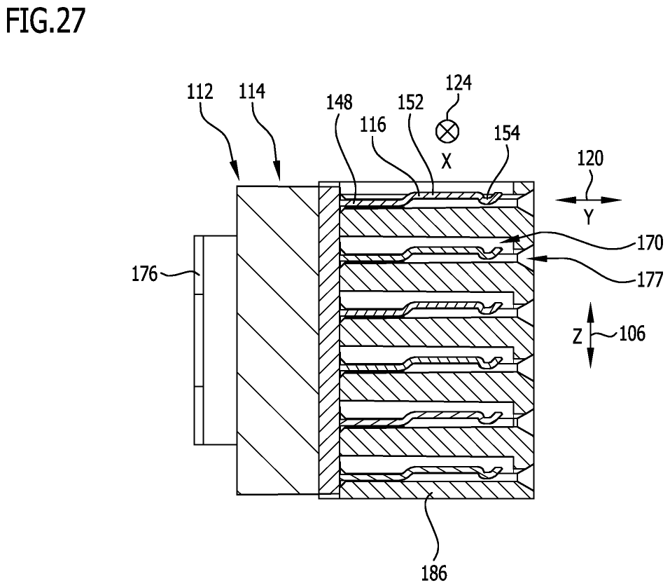

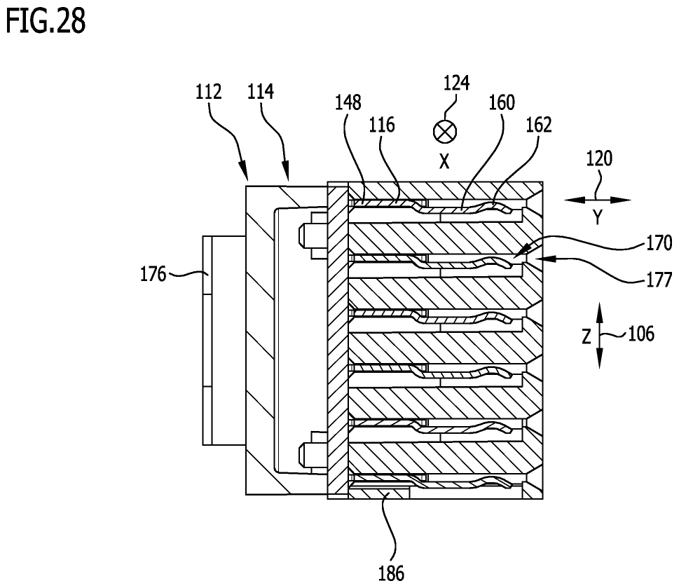

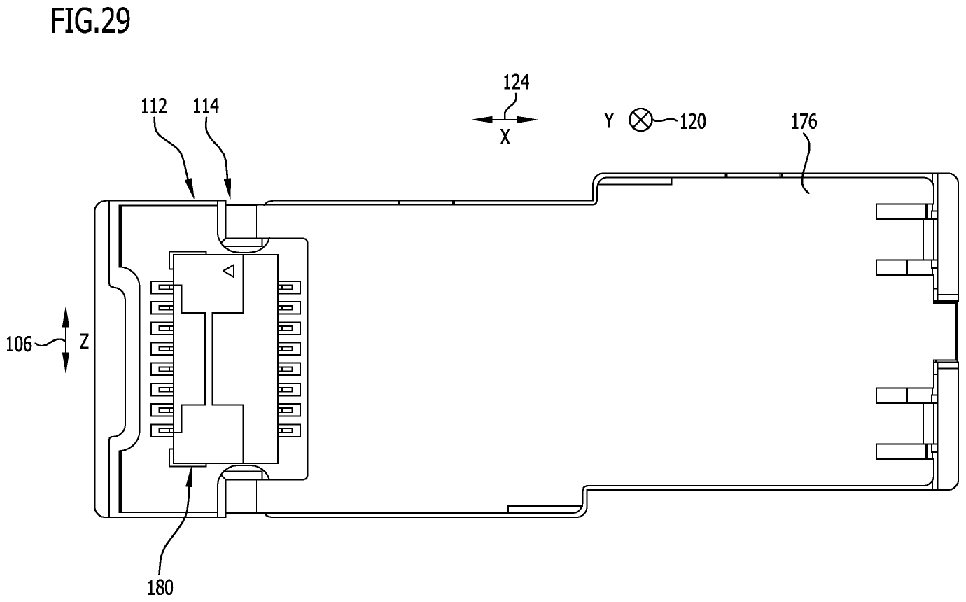

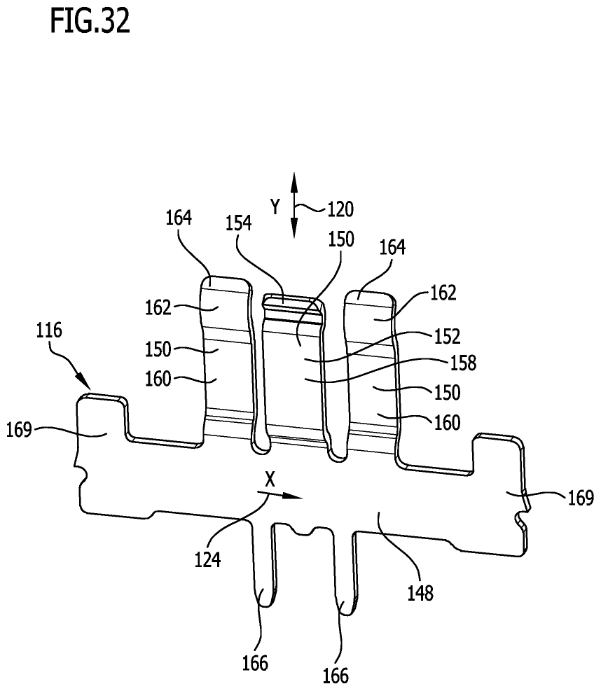

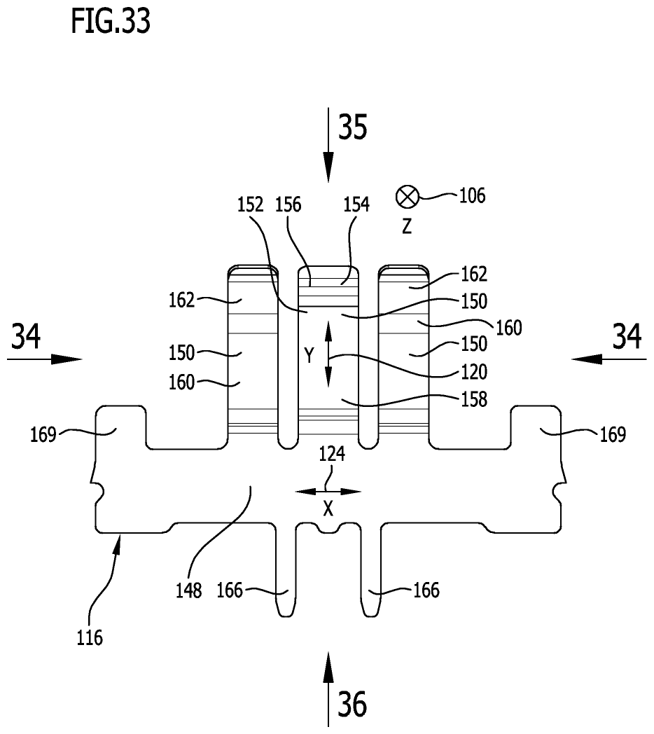

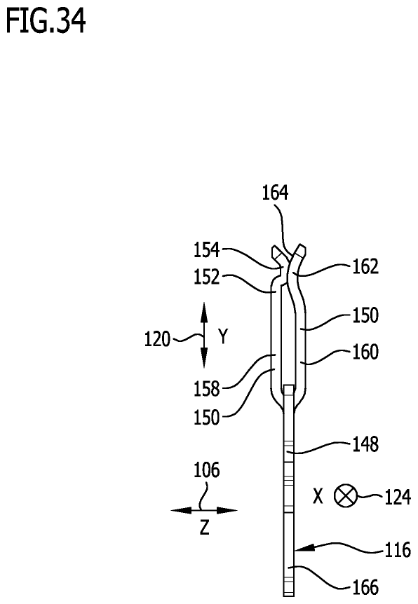

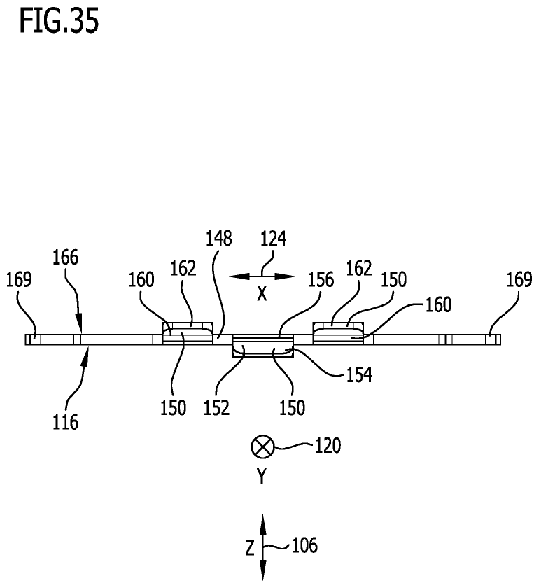

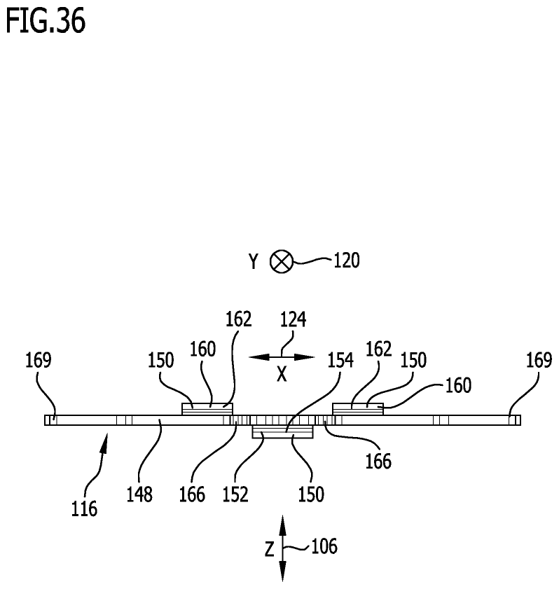

An electrochemical device that is illustrated in FIGS. 1 to 36 and is designated 100 as a whole comprises a stack 102 of electrochemical units 104 that succeed one another in a stack direction 106.

Below, the stack direction 106 is also designated the Z direction of the electrochemical device 100.

The stack 102 may take the form for example of a fuel cell stack, in particular a PEM (polymer-electrolyte membrane) fuel cell stack.

Each of the electrochemical units 104 comprises a respective bipolar plate 108 and further components 110 which, in the drawings, are illustrated only schematically, as a unit.

These further components 110 may comprise in particular an electrochemically active unit, for example a membrane electrode arrangement, gas diffusion layers and seals, for example elastomer seals.

As a result of the further components 110, in each case two bipolar plates 108 that directly succeed one another in the stack 102 in the stack direction 106 are electrically insulated from one another.

During operation of the electrochemical device 100, each of the electrically conductive bipolar plates 108 has an electrical potential that is different from the electrical potential of the adjacent bipolar plates 108.

These electrical potentials, or cell voltages, of the different bipolar plates 108 of the stack 102 are continuously monitored during operation of the electrochemical device 100 in order to carry out control of the electrochemical device 100 as power-efficiently as possible and to identify disruptions to operation of the electrochemical device 100 as early as possible.

So that the electrical potentials or cell voltages of the bipolar plates 108 can be tapped simply and reliably during operation of the electrochemical device 100, the electrochemical device 100 comprises a terminal connector 112 that comprises an electrically insulating housing 114 and a plurality of electrically conductive contact elements 116 arranged in the housing.

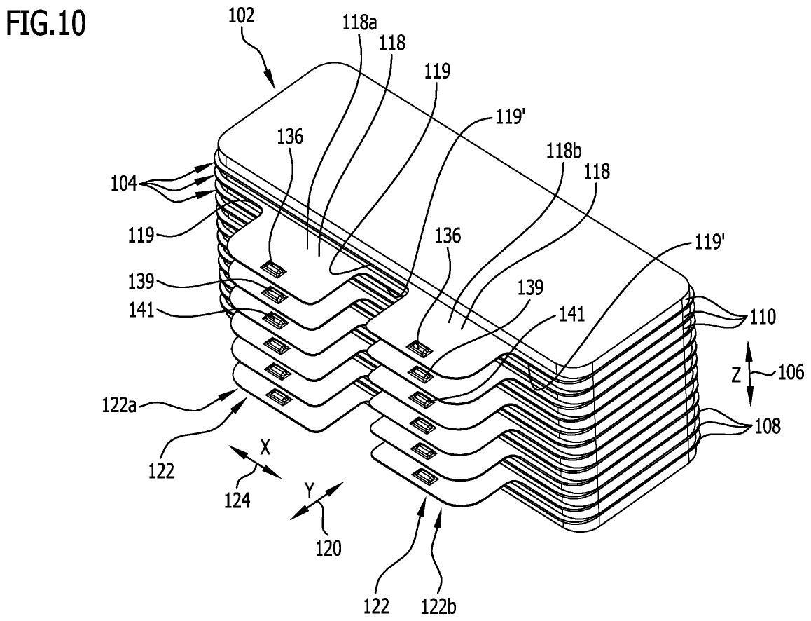

As can best be seen from FIGS. 10 to 18, each of the bipolar plates 108 of the stack 102 comprises a respective terminal element 118, which projects in a contact-making direction 120 beyond lateral edges 119, 119′ of the bipolar plate 108 adjacent to the respective terminal element 118.

Below, this contact-making direction 120 of the bipolar plates 108 is also designated the Y direction.

As can best be seen from FIG. 10, the terminal elements 118 of the bipolar plates 108 of the stack 102 form a plurality of rows 122, preferably two rows 122, of terminal elements 118 that extend in the stack direction 106 or Z direction and are offset from one another in a direction of offset 124 that is oriented perpendicular to the stack direction 106 and perpendicular to the contact-making direction 120.

Below, the direction of offset 124 is also designated the X direction.

In the exemplary embodiment illustrated, the stack 102 of electrochemical units 104 comprises two rows 122a and 122b of terminal elements 118a and terminal elements 118b respectively.

The terminal elements 118 of the bipolar plates 108 that succeed one another in the stack direction 106 are alternately associated with the left-hand row 122a of terminal elements 118a and the right-hand row 122b of terminal elements 118b.

Generally speaking, every nth terminal element 118 of the bipolar plates 108 that succeed one another in the stack direction 106 is associated with each of n rows 122 of terminal elements 118, where n is equal to or greater than 2.

In this way, the spacing between two terminal elements 118 that are arranged directly one above the other in the stack direction 106 is increased to n times the spacing that these terminal elements 118 would have in the absence of distribution of the terminal elements 118 over a plurality of rows 122 of terminal elements 118.

As a result, more space for accommodating contact elements 116 and housing constituent parts of the terminal connector 112 is created between the terminal elements 118 that lie directly one above the other.

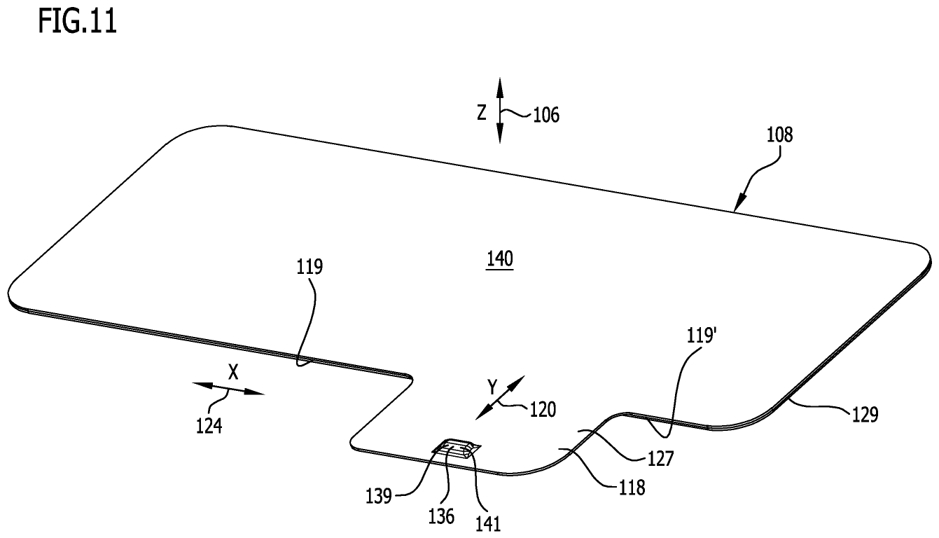

As can best be seen from FIGS. 11 to 18, each bipolar plate 108 comprises a plurality of bipolar plate layers, for example two, for example a first bipolar plate layer 127 and a second bipolar plate layer 129.

The first bipolar plate layer 127 and the second bipolar plate layer 129 are connected to one another in fluid-tight manner at join lines (not illustrated) in order to form medium chambers and medium channels between them.

The terminal element 118 of the bipolar plate 108 is preferably formed with two layers, wherein a first terminal element part 131 is made in one piece with a main body 133 of the first bipolar plate layer 127, and a second terminal element part 135 is made in one piece with a main body 137 of the second bipolar plate layer 129.

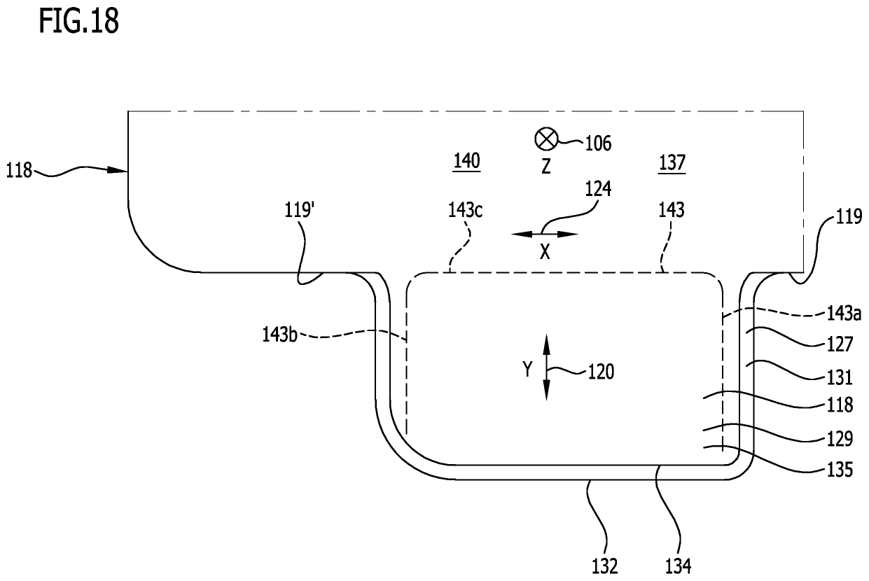

As can best be seen from FIG. 18, a front edge 132 of the first terminal element part 131, extending parallel to the direction of offset 124 (X direction), is offset in the contact-making direction 120 (Y direction) in relation to a front edge 134 of the second terminal element part 135, likewise extending substantially parallel to the direction of offset 124 (X direction), and this makes it easier to mount the terminal connector 112 on the stack 102 of electrochemical units 104.

In the exemplary embodiment illustrated, the front edge 132 of the first terminal element part 131 is offset towards the terminal connector 112 in relation to the front edge 134 of the second terminal element part 135; fundamentally, however, it could also be provided for the front edge 132 of the first terminal element part 131 to be offset away from the terminal connector 112 and towards the main body 133 of the first bipolar plate layer 127, in relation to the front edge 134 of the second terminal element part 135.

In order to enhance the mechanical stability of the terminal element 118, it is preferably provided for the first terminal element part 131 and the second terminal element part 135 to be connected to one another in a substance-to-substance bond, for example by welding along a weld line 143.

The weld line 143 preferably runs outside of the contact zone in which a contact element 116 of the terminal connector 112 makes contact with the terminal element 118 in the mounted condition of the electrochemical device 100.

The weld line 143 may for example be substantially U-shaped.

In this context, two lateral limbs 143a, 143b of the weld line 143 may run for example substantially parallel to the contact-making direction 120 (Y direction), and a web 143c of the weld line 143 that connects the two limbs 143a, 143b to one another may run substantially parallel to the direction of offset 124 (X direction).

In this case, the web 143c of the weld line 143 preferably runs through a region of the terminal element 118 that faces the main body 133 of the first bipolar plate layer 127 and the main body 137 of the second bipolar plate layer 129.

The U-shaped weld line 143 is thus (in the mounted condition of the electrochemical device 100) open towards the terminal connector 112.

The terminal element 118 of the bipolar plate 108 has a contact-making bead 136 with which in each case an associated contact element 116 of the terminal connector 112 is engageable in order to make an electrically conductive contact between the bipolar plate 108 and the respectively associated contact element 116 of the terminal connector 112, an arrangement which will be explained in more detail below.

The contact-making bead 136 at the same time serves as a latching element 139 of the terminal element 118, in the form of a latching bead 141 that is latchable to an associated contact element 116 of the terminal connector 112.

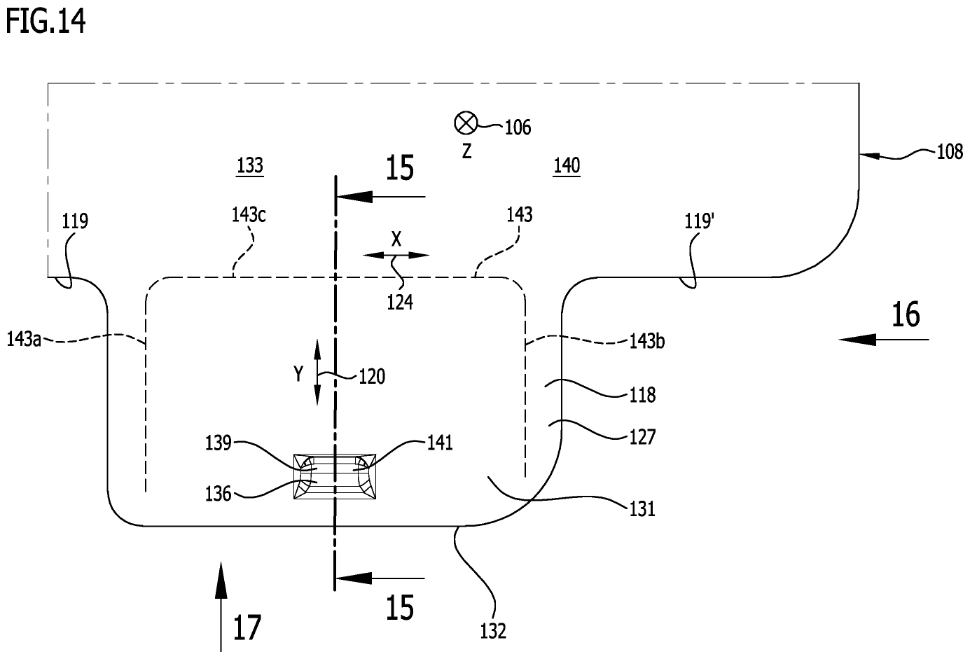

As can be seen for example from the plan view of FIG. 14, the contact-making bead 136 and latching bead 141 extends in the direction of offset 124 or X direction of the bipolar plate 108.

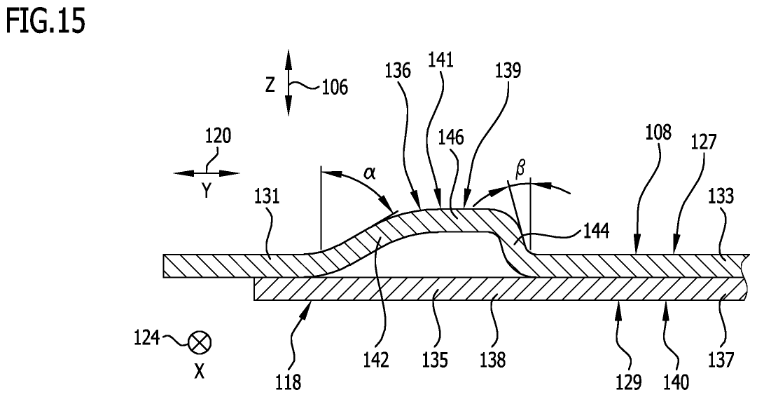

As can best be seen from the sectional illustration of FIG. 15, in this embodiment of a terminal element 118 the contact-making bead 136 and latching bead 141 is made in only one of the bipolar plate layers 127 and 129, for example the first bipolar plate layer 127.

The respectively other bipolar plate layer, in the case of the illustration in the drawings the second bipolar plate layer 129, may by contrast take a substantially planar form in its region 138 opposite the contact-making bead 136 and latching bead 141.

The main body 133 of the first bipolar plate layer 127 and the main body 137 of the second bipolar plate layer 129 together form a main body 140 of the bipolar plate 108.

As can best be seen from FIG. 15, the contact-making bead 136 and latching bead 141 has a rising flank 142 remote from the main body 140 of the bipolar plate 108, and a falling flank 144 facing the main body 140 of the bipolar plate 108.

Arranged between the rising flank 142 and the falling flank 144 of the contact-making bead 136 is a crest 146 of the contact-making bead 136 and latching bead 141.

In order to make it easier to bring the contact element 116 into engagement with the contact-making bead 136 and latching bead 141, it is preferably provided for the rising flank 142 to be inclined in relation to the stack direction 106 by an angle α that is greater than an angle β by which the falling flank 144 is inclined in relation to the stack direction 106.

The angle α is preferably more than 45°, in particular more than 50°, particularly preferably more than 60°.

Further, the angle α is preferably less than 85°, in particular less than 80°, particularly preferably less than 70°.

The angle β is preferably more than 5°, in particular more than 10°, particularly preferably more than 20°.

Further, the angle β is preferably less than 45°, in particular less than 40°, particularly preferably less than 30°.

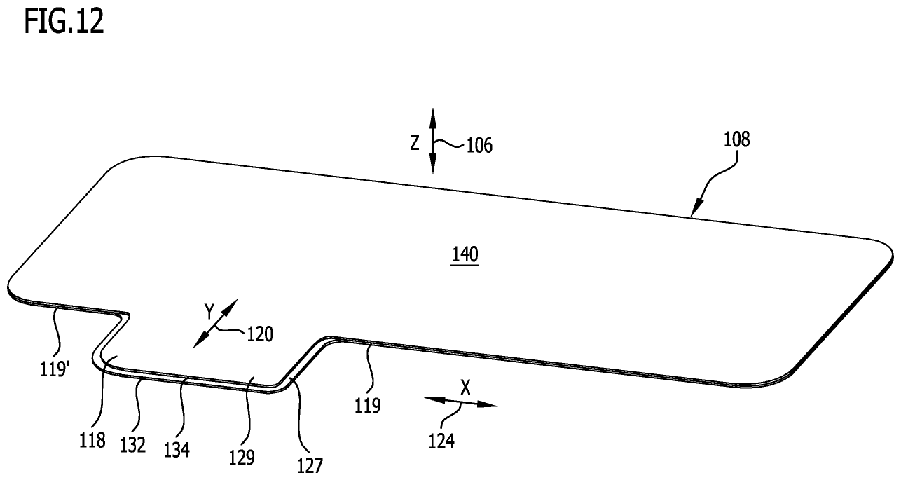

As can be seen in particular from FIGS. 12, 16 and 18, it may be provided for the first bipolar plate layer 127 to overhang the second bipolar plate layer 129 in an edge region of the terminal element 118.

The first bipolar plate layer 127 may be an anode-side bipolar plate layer that delimits a flow field (not illustrated) for the anode gas of the electrochemical device 100.

In that case, the second bipolar plate layer 129 is a cathode-side bipolar plate layer that delimits a flow field (not illustrated) for the cathode gas of the electrochemical device 100.

Fundamentally, however, it may also be provided for the first bipolar plate layer 127 to be a cathode-side bipolar plate layer that delimits a flow field for a cathode gas of the electrochemical device 100, and for the second bipolar plate layer 129 to be an anode-side bipolar plate layer that delimits a flow field for an anode gas of the electrochemical device 100.

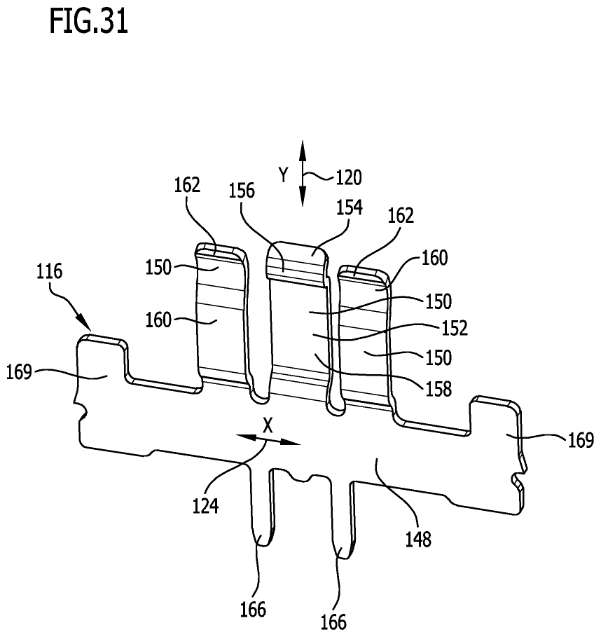

One of the contact elements 116 of the terminal connector 112 which, in the mounted condition of the terminal connector 112, come into engagement with the terminal element 118 of a respectively associated bipolar plate 108 is illustrated by itself in FIGS. 31 to 36.

Each contact element 116 comprises a base part 148 from which a plurality of arms 150 project in the contact-making direction 120.

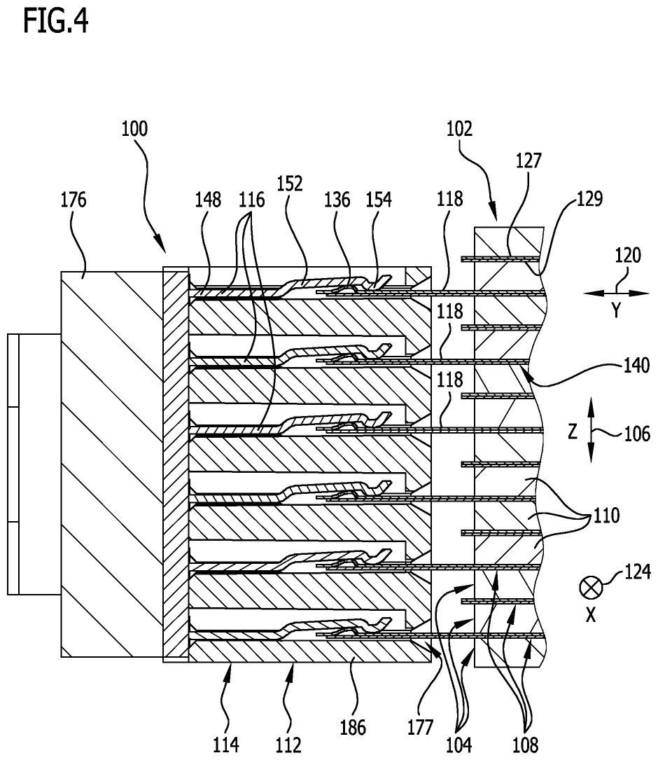

In the exemplary embodiment illustrated here, the contact element 116 comprises a latching arm 152 which is preferably arranged centrally on the base part 148 and which, in the mounted condition of the terminal connector 112, engages behind the latching bead 141 of a terminal element 118 (which is associated with the contact element 116) of a bipolar plate 108 of the stack 102 of electrochemical units 104, as can be seen for example in the sectional illustration of FIG. 4.

In this context, a part of the latching arm 152 that engages behind the latching bead 141 in the mounted condition of the terminal connector 112 takes the form of a latching tongue 154.

The latching tongue 154 is for example curved into an arc shape as seen in cross section, wherein, in the mounted condition of the terminal connector 112, a convexly curved outer side 156 of the latching tongue 154 abuts against a region of the terminal element 118 that lies between the main body 140 of the bipolar plate 108 and the latching bead 141 of the bipolar plate 108.

In this context, the latching arm 152 of the contact element 116 and the latching bead 141 may take a form and be arranged relative to one another such that, in the mounted condition of the terminal connector 112, a web region 158 of the latching arm 152 that connects the latching tongue 154 to the base part 148 of the contact element 116 abuts against the crest 146 of the latching bead 141.

Further, the contact element 116 comprises two contact-making arms 160, which likewise project from the base part 148 of the contact element 116 in the contact-making direction 120 and, in this embodiment of a contact element 116, have substantially the same extent in the contact-making direction 120 as the latching arm 152.

The latching arm 152 is arranged between the two contact-making arms 160, preferably centrally between the contact-making arms 160.

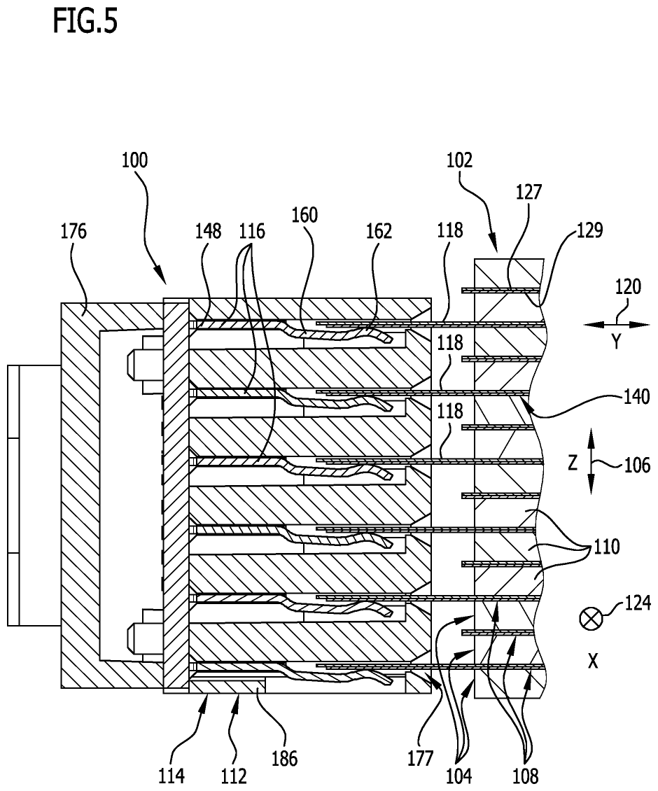

The contact-making arms 160 terminate in a contact-making region 162 which, in the mounted condition of the terminal connector 112, abuts against the second bipolar plate layer 129 in the region of the terminal element 118, an arrangement which can be seen particularly clearly from the sectional illustration of FIG. 5.

The contact-making region 162 may be curved into an arc shape, wherein, in the mounted condition of the terminal connector 112, preferably a convexly curved outer side 164 of the contact-making region 162 abuts electrically conductively against the terminal element 118.

In the mounted condition of the terminal connector 112, therefore, the two contact-making arms 160 of the contact element 116 abut against a first side of the terminal element 118 of the respectively associated bipolar plate 108, while, in the mounted condition of the terminal connector 112, the latching arm 152 abuts against a second side of the terminal element 118 which is remote from the first side of the terminal element 118.

The terminal element 118 of the bipolar plate 108 is clamped, between the contact-making arms 160 and the latching arm 152 of the contact element 116 on the other hand, when the contact element 116 is in engagement with the terminal element 118 of the bipolar plate 108.

The latching arm 152 and the contact-making arms 160 of the contact element 116 preferably have an elasticity which, in the mounted condition of the terminal connector 112, elastically biases the latching arm 152 and the contact-making arms 160 against the terminal element 118 of the respectively associated bipolar plate 108.

For this purpose, the contact element 116 is preferably made from a resilient material.

In particular, the contact element 116 may be made from a resilient metal material.

Further, the contact element 116 has one or more, for example two, terminal pins 166 by which the contact element 116 is fixable to the housing 114 of the terminal connector 112.

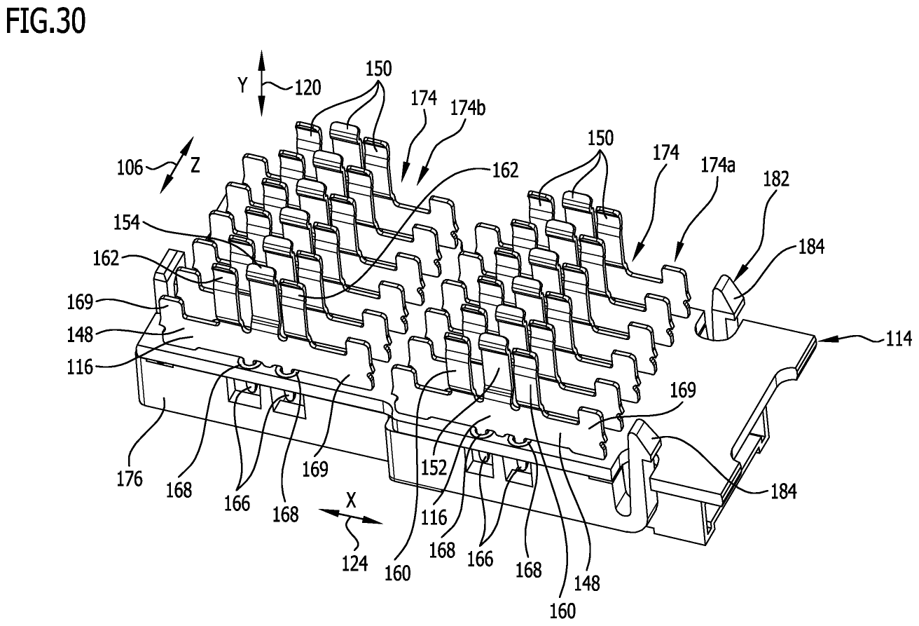

As can be seen for example from FIG. 30, the terminal pins 166 extend through a respective terminal sleeve 168 of the housing 114 and are preferably electrically conductively connected to these.

The terminal pins 166 preferably project from the base part 148 of the contact element 116 in the contact-making direction 120, in the opposite direction to the latching arm 152 and the contact-making arms 160.

The end regions of the base part 148 of the contact element 116 take the form of support elements, by which the contact element 116 is laterally supported when it is arranged in a contact element receptacle 170 of the terminal connector 112.

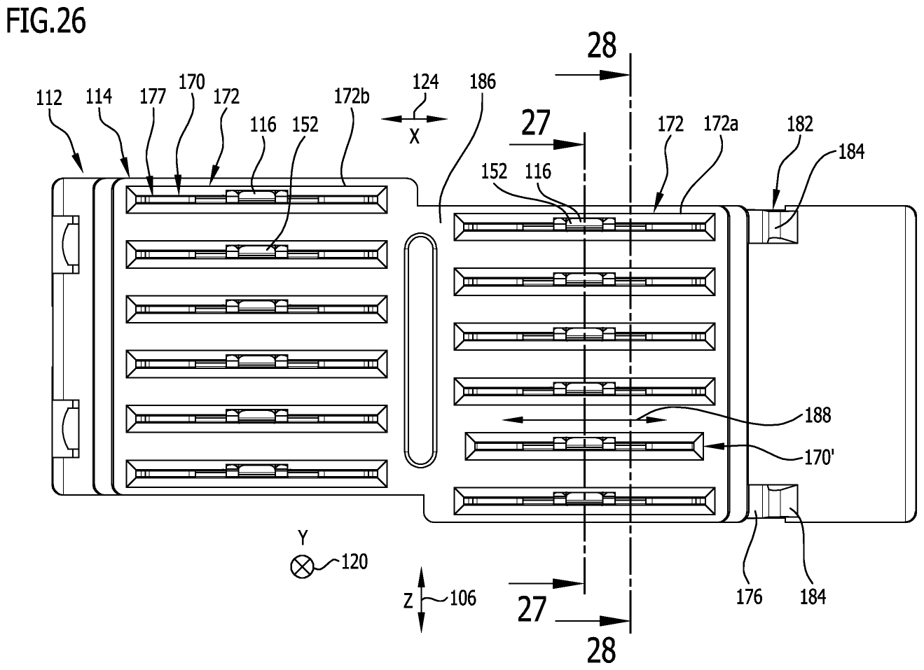

As can be seen for example from the plan view of the front side of the terminal connector 112 in FIG. 26, the terminal connector 112 comprises a plurality of rows 172, in the illustrated exemplary embodiment two rows 172, of contact element receptacles 170 which, in the mounted condition of the terminal connector 112, extend in the stack direction 106 and are offset from one another in the direction of offset 124 running perpendicular to the stack direction 106.

Consequently, the terminal connector 112 also comprises a plurality of rows 174, in the illustrated exemplary embodiment two rows 174, of contact elements 116 which, in the mounted condition of the terminal connector 112, each extend in the stack direction 106 and are offset from one another in the direction of offset 124 running perpendicular to the stack direction 106.

In this context, in the mounted condition of the terminal connector 112 each row 174a or 174b of contact elements 116 makes electrically conductive contact with every second one of the bipolar plates 108 that succeed one another in the stack direction 106 of the stack 102 of electrochemical units 104.

Generally speaking, it is provided for every nth one of the bipolar plates 108 that succeed one another in the stack direction 106 to make electrically conductive contact with each of n rows 174 of contact elements 116 in the mounted condition of the terminal connector 112, where n is equal to or greater than 2.

As can best be seen from FIG. 30, the contact elements 116 are fixed to a rear part 176 of the housing 114 of the terminal connector 112.

This rear part 176 of the housing 114 comprises electrical lines that connect the terminal pins 166 of each contact element 116 to a respective contact pin 178 of a plug terminal 180 that is formed on the rear part 176 of the housing 114.

Connectable to the plug terminal 180 of the terminal connector 112 is a plug terminal, of a shape complementary thereto, of a connecting cable (not illustrated) by which an electrically conductive connection is producible between the contact elements 116 of the terminal connector 112 and the inputs of a monitoring device (not illustrated) of the electrochemical device 100.

This monitoring device may form part of a control device of the electrochemical device 100, which controls operation of the electrochemical device depending on the respectively detected electrical potentials or cell voltages of the bipolar plates 108 in the stack 102 of electrochemical units 104.

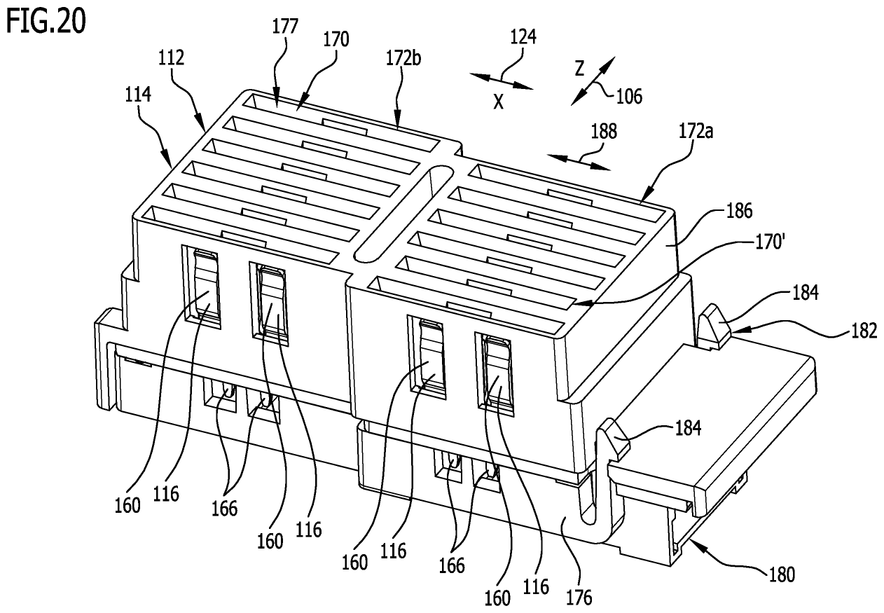

As can be seen for example from FIG. 20, the rear part 176 of the housing 114 of the terminal connector 112 is latched to a front part 186 of the housing 114 using a latching device 182, which may comprise for example one or more latching hooks 184.

The contact element receptacles 170 in which the contact elements 116 of the terminal connector 112 are received take the form of passage openings in the front part 186 of the housing 114.

The extent of the contact element receptacles 170 in the longitudinal direction 188 of the housing 114 of the terminal connector 112, which in the mounted condition of the terminal connector 112 is oriented parallel to the direction of offset 124 (or X direction), is greater than the extent of the terminal elements 118 of the bipolar plates 108 of the electrochemical device 100 in the direction of offset 124, in order to enable manufacturing tolerances and positioning tolerances of the terminal elements 118 of the bipolar plates 108 in the stack 102 of electrochemical units 104 to be compensated, and to enable the terminal connector 112 to be pushed onto the terminal elements 118 of the bipolar plates 108 easily even where there are such manufacturing and positioning tolerances.

However, a contact element receptacle 170′ of the housing 114 of the terminal connector 112 has a smaller extent in the longitudinal direction 188 of the terminal connector 112 than the other contact element receptacles 170, with the result that the terminal element 118 that is associated with the contact element 116 of this contact element receptacle 170′ is inserted into the contact element receptacle 170′ with only little play.

In that case, the engagement between the terminal element 118 and this contact element receptacle 170′ prevents undesired displacement of the terminal connector 112 relative to the bipolar plates 108 of the stack 102 of electrochemical units 104 when the terminal connector 112 is in the mounted condition, and in particular during operation of the electrochemical device 100.

On the front side of the housing 114 of the terminal connector 112, the contact element receptacles 170, 170′ open into a respective insertion funnel 177, which tapers towards the interior of the respective contact element receptacle 170, 170′ and which has delimitation faces that are inclined in relation to the contact-making direction 120, in order to make it easier for the terminal elements 118 of the bipolar plates 108 to enter the respectively associated contact element receptacles 170, 170′.

The rear part 176 and the front part 186 of the housing 114 of the terminal connector 112 are preferably made from an electrically insulating plastics material.

For example, the rear part 176 and/or the front part 186 of the housing 114 may be made from a polyamide material.

The rear part 176 and/or the front part 186 of the housing 114 of the terminal connector 112 are preferably made by an injection moulding method.

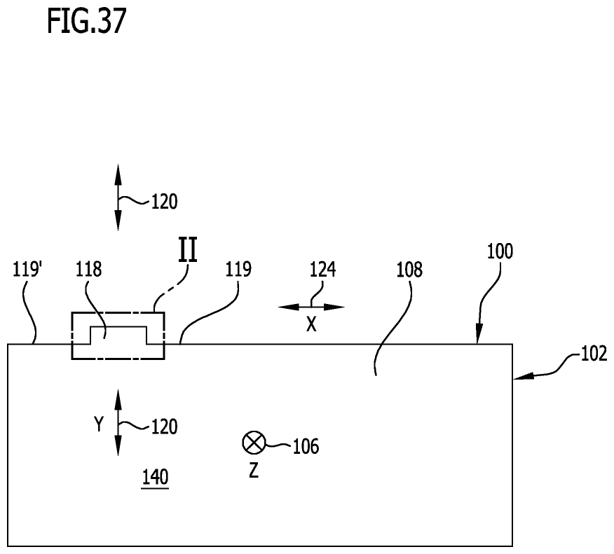

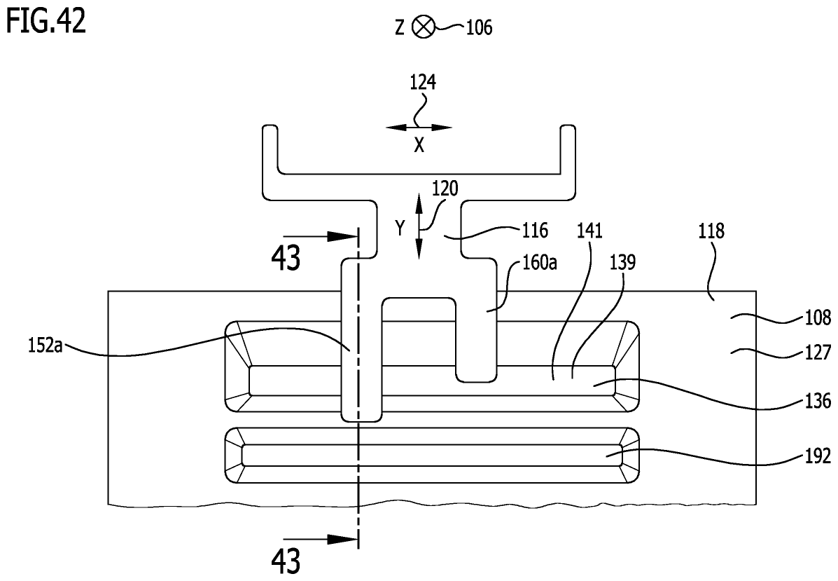

A second embodiment of an electrochemical device 100, illustrated in FIGS. 37 to 43, likewise comprises a stack 102 of electrochemical units 104 that succeed one another in a stack direction 106.

In this case, each electrochemical unit 104 comprises a bipolar plate 108 as illustrated in FIG. 37.

Each bipolar plate 108 comprises a terminal element 118, which projects in a contact-making direction 120 beyond lateral edges 119, 119′ of the bipolar plate 108 adjacent to the terminal element 118.

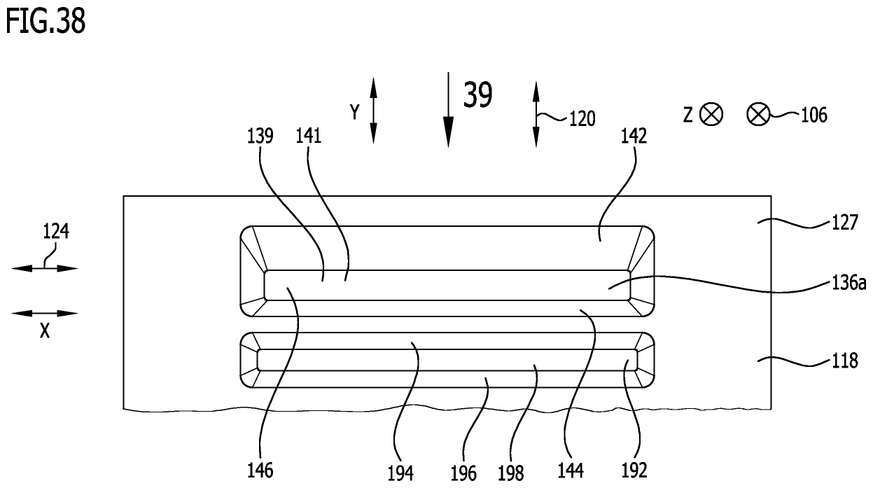

As can be seen from FIG. 38, the terminal element 118 comprises a first contact-making bead 136a, which extends in a direction of offset 124 or X direction.

The first contact-making bead 136a at the same time serves as a first latching element 139a of the terminal element 118, in the form of a first latching bead 141a that is latchable to an associated contact element 116 of the terminal connector 112.

The first contact-making bead 136a and first latching bead 141a is formed in one of the bipolar plate layers of the bipolar plate 108, for example in the first bipolar plate layer 127.

The first contact-making bead 136a and first latching bead 141a is produced for example by a shaping procedure performed on the relevant bipolar plate layer 127 or 129, for example a stamping procedure or deep-drawing procedure.

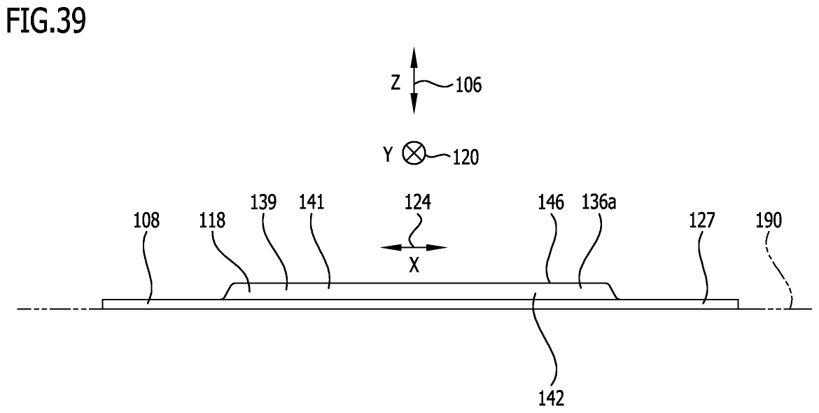

In FIGS. 38 and 39, only the first bipolar plate layer 127, which is provided with the first contact-making bead 136a and first latching bead 141a, is illustrated.

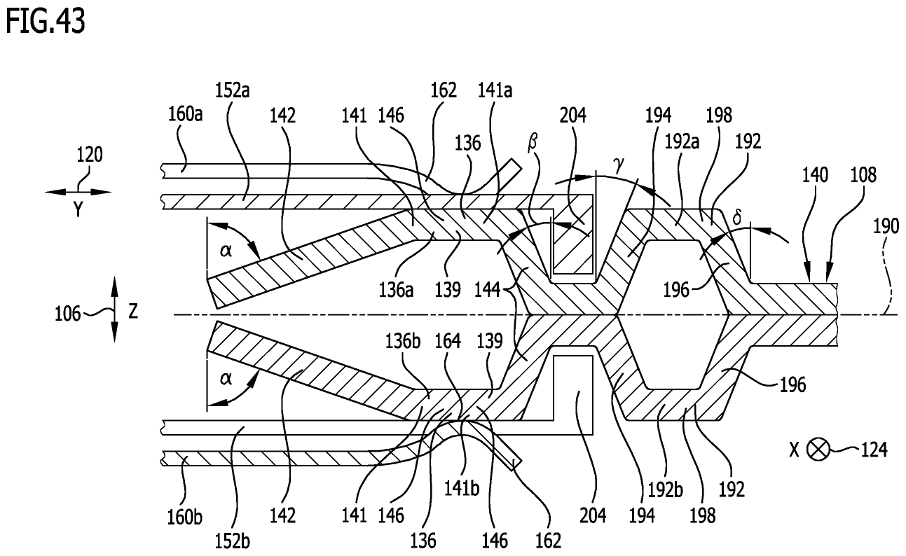

The second bipolar plate layer 129 may be provided with a second contact-making bead 136b that takes a form mirror-symmetrical to the first contact-making bead 136a, in respect of a centre plane 190 of the bipolar plate 108 that runs perpendicular to the stack direction 106 (see FIG. 43).

The second contact-making bead 136b at the same time serves as a second latching element 139b of the terminal element 118, in the form of a second latching bead 141b that is latchable to an associated contact element 116 of the terminal connector 112.

Each of the contact-making beads 136a, 136b and latching beads 141a, 141b has a rising flank 142 remote from the main body 140 of the bipolar plate 108 and a falling flank 144 facing the main body 140 of the bipolar plate 108.

Arranged between the rising flank 142 and the falling flank 144 of each contact-making bead 136 and latching bead 141 is a crest 146 of the contact-making bead 136 and latching bead 141.

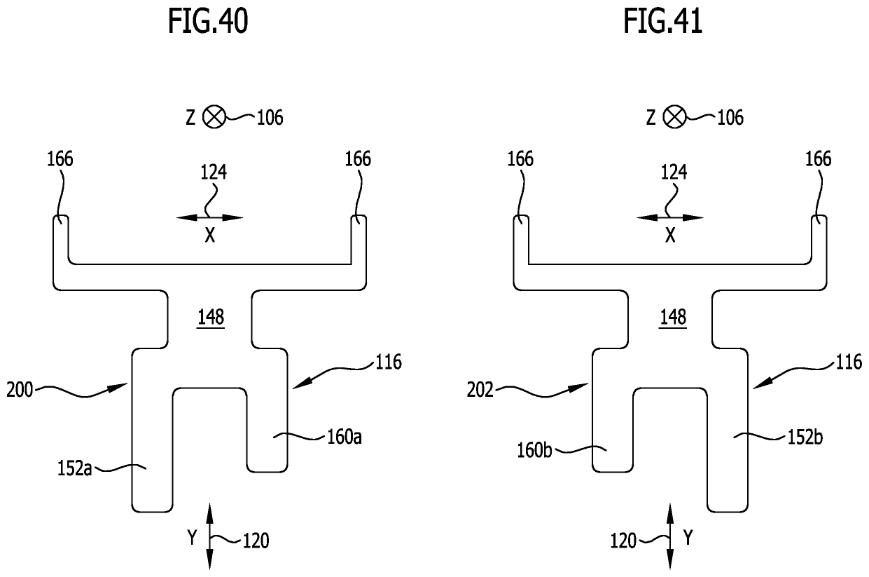

In order to make it easier to bring the contact element 116 of the terminal connector 112 of the electrochemical device 100 illustrated in FIGS. 40 to 43 into engagement with the contact-making beads 136a, 136b and latching beads 141a, 141b, it is preferably provided for the rising flank 142 of the respective contact-making bead 136a, 136b and latching bead 141a, 141b to be inclined in relation to the stack direction 106 by an angle α that is greater than an angle β by which the falling flank 144 is inclined in relation to the stack direction 106.

The angle α is preferably more than 45°, in particular more than 50°, particularly preferably more than 60°.

Further, the angle α is preferably less than 85°, in particular less than 80°, particularly preferably less than 70°.

The angle β is preferably more than 5°, in particular more than 10°, particularly preferably more than 20°.

Further, the angle β is preferably less than 45°, in particular less than 40°, particularly preferably less than 30°.

Moreover, in this embodiment of the electrochemical device 100, it is provided for the terminal element 118 of the bipolar plate 108 to comprise, in addition to the contact-making beads 136 and latching beads 141, two stop beads 192 (see in particular FIGS. 38, 42 and 43).

Here, a first stop bead 192a is formed in the first bipolar plate layer 127 and a second stop bead 192b is formed in the second bipolar plate layer 129.

Each of the stop beads 192 may for example be formed by a shaping procedure performed on the respective bipolar plate layer 127, 129, for example a stamping procedure or deep-drawing procedure.

The first stop bead 192a and the second stop bead 192b may take a form substantially mirror-symmetrical to one another in respect of the centre plane 190 of the bipolar plate 108.

Each of the stop beads 192 extends in the direction of offset 124 or X direction of the stack 102 of electrochemical units 104.

Each of the stop beads 192 has a first flank 194, which faces the respectively associated contact-making bead 136a, 136b and latching bead 141a, 141b, and a second flank 196, remote from the respectively associated contact-making bead 136a, 136b and latching bead 141a, 141b.

Arranged between the first flank 194 and the second flank 196 of the stop bead 192 is a crest 198 of the stop bead 192.

The first flank 194 of the stop bead 192 is inclined in relation to the stack direction 106 by an angle γ, and the second flank 196 of the stop bead 192 is inclined in relation to the stack direction 106 by an angle δ.

In the embodiment illustrated in the drawings, it is provided for the angle γ to be substantially the same size as the angle δ.

The angles γ and δ are preferably substantially the same size as or larger than the angle β by which the falling flanks 144 of the contact-making beads 136a, 136b and latching beads 141a, 141b are inclined in relation to the stack direction 106, and/or are substantially the same size as or smaller than the angle α by which the rising flanks 142 of the contact-making beads 136a, 136b and latching beads 141a, 141b are inclined in relation to the stack direction 106.

The angle γ and/or the angle δ is preferably more than 5°, in particular more than 10°, particularly preferably more than 20°.

Further, the angle γ and/or the angle δ is preferably less than 45°, in particular less than 40°, particularly preferably less than 30°.

In this embodiment, each contact element 116 of the terminal connector 112 of the electrochemical device 100 comprises two parts, namely an upper part 200, illustrated in FIG. 40, and a lower part 202, illustrated in FIG. 41.

The upper part 200 of the contact element 116, illustrated in FIG. 40, comprises a base part 148 from which an upper latching arm 152a and an upper contact-making arm 160a project in the contact-making direction 120.

Further, the upper part 200 of the contact element 116 comprises one or more, in the illustrated exemplary embodiment two, terminal pins 166, by which the upper part 200 of the contact element 116 is fixable to a housing (not illustrated) of the terminal connector 112 of the electrochemical device 100.

As in the first embodiment of an electrochemical device 100, illustrated in FIGS. 1 to 36, in this embodiment too the housing of the terminal connector 112 comprises electrical lines that connect the terminal pins 166 to a respective plug terminal of the housing.

The lower part 202 of the contact element 116, illustrated in FIG. 41, comprises a lower contact-making arm 160b and a lower latching arm 152b which project from a base part 148 of the lower part 202 of the contact element 116 in the contact-making direction 120.

Further, the lower part 202 of the contact element 116 comprises one or more, in the illustrated exemplary embodiment two, terminal pins 166, by which the lower part 202 of the contact element 116 is fixable to the housing of the terminal connector 112.

Arranged and fixed in a contact element receptacle (not illustrated) of the terminal connector 112 are respectively an upper part 200 and a lower part 202 of a contact element 116 such that the upper latching arm 152a of the upper part 200 is arranged above the lower contact-making arm 160b of the lower part 202, as seen in the stack direction 106, and the upper contact-making arm 160a of the upper part 200 is arranged above the lower latching arm 152b of the lower part 202 of the contact element 116, as seen in the stack direction 106.

As can best be seen from FIG. 43, at its free end each of the latching arms 152a, 152b comprises a latching lug 204 by which, in the mounted condition of the terminal connector 112, the relevant latching arm 152a, 152b engages behind the first latching bead 141a and the second latching bead 141b respectively of the terminal element 118 associated with the contact element 116 (see FIG. 43).

In this context, the movement of pushing the latching arms 152a, 152b on in the direction of the main body 140 of the bipolar plate 108 is limited by the respectively associated stop bead 192.

In the mounted condition of the terminal connector 112, the latching lug 204 of each latching arm 152a, 152b is thus arranged in the region between the respectively associated latching bead 141a, 141b and the respectively associated stop bead 192.

Thus, the contact element 116 is latched onto the respectively associated terminal element 118 of a bipolar plate 108 by the latching arms 152a, 152b.

The contact-making arms 160a, 160b of the contact element 116 each terminate in a contact-making region 162 which, in the mounted condition of the terminal connector 112, abuts against the respectively associated contact-making bead 136a or 136b.

Preferably, the contact-making regions 162 of the contact-making arms 160a, 160b abut against the crest 146 of the respectively associated contact-making bead 136a, 136b.

Each contact-making region 162 may take a form that is curved into an arc shape, wherein, in the mounted condition of the terminal connector 112, preferably a convexly curved outer side 164 of the contact-making region 162 abuts against the respectively associated contact-making bead 136a, 136b.

In the mounted condition of the terminal connector 112, the contact-making beads 136a, 136b of the terminal element 118 are clamped between the contact-making arms 160a, 160b of the respectively associated contact element 116 of the terminal connector 112.

The upper part 200 and the lower part 202 of the contact element 116 are preferably made from an electrically conductive resilient material.

Otherwise, the second embodiment of an electrochemical device, which is illustrated in FIGS. 37 to 43, corresponds, as regards its structure, functioning and mode of manufacture, to the first embodiment illustrated in FIGS. 1 to 36, and in this respect reference is made to the description thereof above.

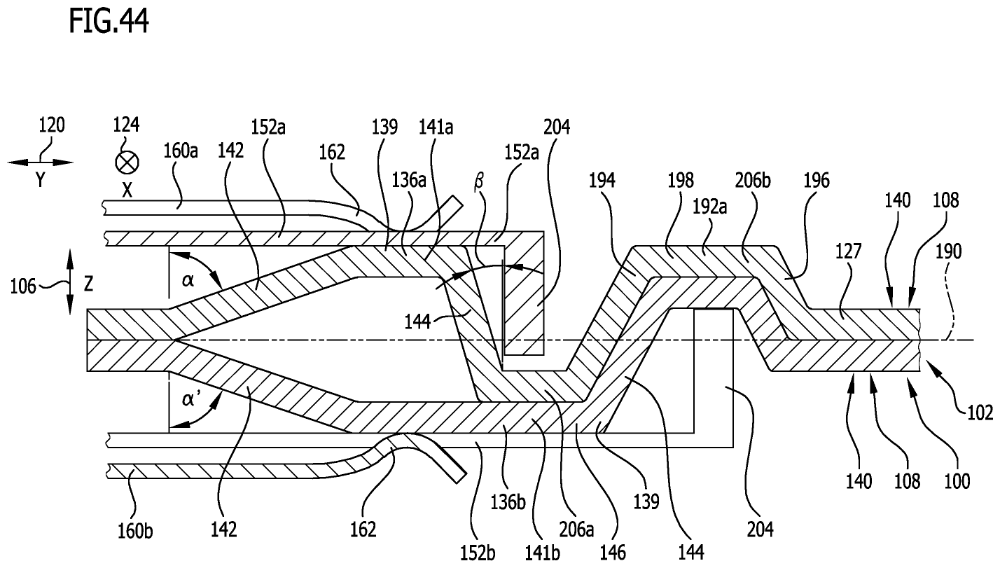

A third embodiment of an electrochemical device 100, illustrated in FIG. 44, differs from the second embodiment illustrated in FIGS. 37 to 43 in that the first contact-making bead 136a and first latching bead 141a, and the second contact-making bead 136b and second latching bead 141b, are formed asymmetrically to one another in respect of mirror symmetry along the centre plane 190 of the bipolar plate 108 that runs perpendicular to the stack direction 106.

In this context, it is in particular provided for a first recess 206a to be made in the first bipolar plate layer 127 between the first contact-making bead 136a and first latching bead 141a, which is formed in the first bipolar plate layer 127, and the first stop bead 192a, likewise formed in the first bipolar plate layer 127, and for the first recess 206a to extend beyond the centre plane 190 of the bipolar plate 108 to the second contact-making bead 136b and second latching bead 141b, which is formed in the second bipolar plate layer 129, and preferably to hug the crest 146 and the falling flank 144 of the second contact-making bead 136b and second latching bead 141b.

In this way, the effective height of the first contact-making bead 136a and first latching bead 141a is increased by comparison with the second embodiment of an electrochemical device 100, described above.

In this third embodiment, instead of a stop bead 192 in the second bipolar plate layer 129 there is made a second recess 206b, which is arranged between the second contact-making bead 136b and second latching bead 141b and the main body 140 of the bipolar plate 108.

The second recess 206b extends beyond the centre plane 190 of the bipolar plate 108 and into the stop bead 192a that is formed in the first bipolar plate layer 127.

Preferably, the second recess 206b is made substantially complementary to the stop bead 192a.

In this case, the recess 206b hugs the first flank 194, the crest 198 and the second flank 196 of the stop bead 192a.

Since, in this embodiment, the recess 206a in the first bipolar plate layer 127 is supported against the second contact-making bead 136b and second latching bead 141b of the second bipolar plate layer 129, and the recess 206b in the second bipolar plate layer 129 is supported against the stop bead 192a of the first bipolar plate layer 127, in this embodiment the bead structure of the terminal element 118 of the bipolar plate 108 is reinforced.

As can be seen from FIG. 44, in this embodiment, in the mounted condition of the terminal connector 112, the upper latching arm 152a engages in the first recess 206a in the first bipolar plate layer 127, while the lower latching arm 152b engages in the second recess 206b in the second bipolar plate layer 129.

In this embodiment, the positions of the latching lugs 204 of the upper latching arm 152a and the lower latching arm 152b are offset from one another in the contact-making direction 120 or Y direction.

Whereas, in the second embodiment illustrated in FIGS. 37 to 43, the upper latching arm 152a and the lower latching arm 152b are of substantially the same length, the latching arms 152a and 152b in this third embodiment have different lengths.

For example, it may be provided for the lower latching arm 152b to have a greater length than the upper latching arm 152a.

In this embodiment, the angle α by which the first rising flank 142a of the first contact-making bead 136a and first latching bead 141a is inclined in relation to the stack direction 106, and the angle α′ by which the second rising flank 142b of the second contact-making bead 136b and second latching bead 141b is inclined in relation to the stack direction 106, may be substantially the same size or different from one another.

For example, it may be provided for the angle α to be smaller than the angle α′, preferably by at least 5°.

Otherwise, the third embodiment of an electrochemical device, which is illustrated in FIG. 44, corresponds, as regards its structure, functioning and mode of manufacture, to the second embodiment illustrated in FIGS. 37 to 43, and in this respect reference is made to the description thereof above.

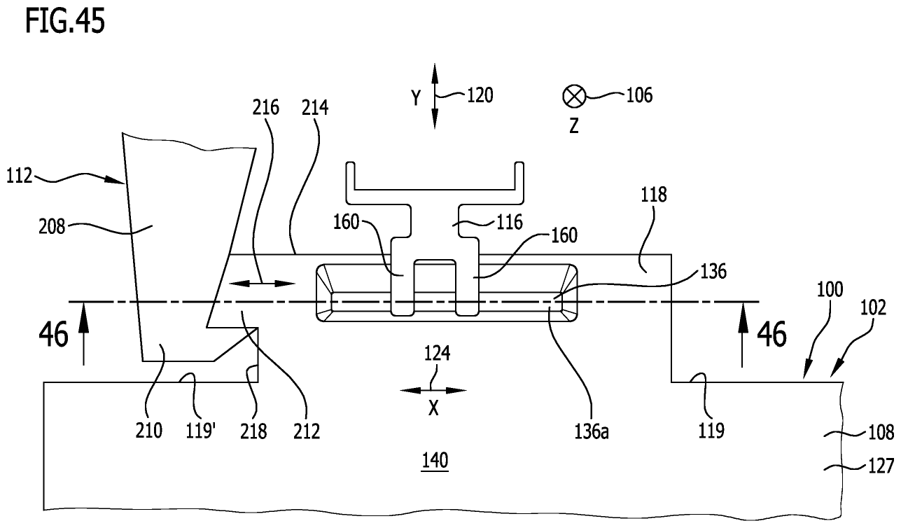

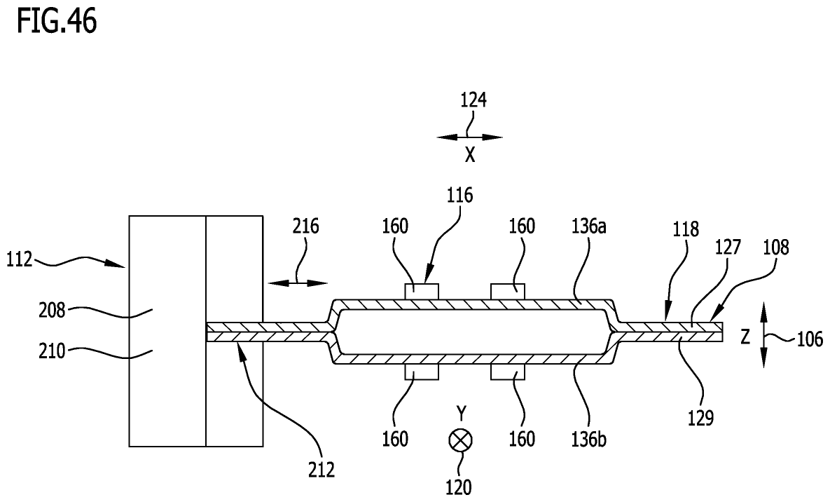

A fourth embodiment of an electrochemical device 100, illustrated in FIGS. 45 and 46, differs from the second embodiment illustrated in FIGS. 37 to 43 in that the function of the terminal element 118 making electrical contact using the respectively associated contact element 116 of the terminal connector 112, on the one hand, and the function of latching the terminal connector 112 to the bipolar plate 108, on the other, are separate from one another.

In this embodiment, each contact element 116 of the terminal connector 112 has only contact-making arms 160 and no latching arms 152.

For this reason, in this embodiment the stop bead 192 on the terminal element 118 can be dispensed with.

In this embodiment, the latching function is taken on by a latch element 208, for example in the form of a latching hook 210, which in the mounted condition of the terminal connector 112 engages behind a latching projection 212 of the terminal element 118.

Here, the latching projection 212 of the terminal element 118 projects from a lateral edge 218 of the terminal element 118, in a direction of projection 216 that runs parallel to a front edge 214 of the terminal element 118.

The direction of projection 216 preferably runs substantially parallel to the direction of offset 124 or X direction of the stack 102 of electrochemical units 104.

The latch element 208 is preferably made from an electrically insulating material.

The latch element 208 may be made from a plastics material, for example a polyamide material.

The latch element 208 may be made in one piece with the housing of the terminal connector 112.

The latch element 208 may for example be made by an injection moulding procedure.

In this embodiment, it is provided for each row 122 of terminal elements 118 to carry the latching projections 212 on a side remote from the respectively other row 122 of terminal elements 118, with the result that, when the terminal connector 112 is mounted on the stack 102 of electrochemical units 104, a respective latch element 208 of the terminal connector 112 engages behind the terminal elements 118 of different rows 122 of terminal elements 118 from mutually opposite sides.

In this way, a relative movement between the terminal elements 118 on the one hand and the terminal connector 112 on the other in the direction of offset 124 or X direction of the stack 102 of electrochemical units 104 is prevented, even though each individual terminal element 118 engages with a latch element 208 at only one of its lateral edges 218.

As can be seen from FIG. 46, in this embodiment, when the terminal connector 112 is mounted on the stack 102 of electrochemical units 104 the contact-making beads 136a, 136b of the terminal element 118 are clamped between the two upper contact-making arms 160a and the two lower contact-making arms 160b of the contact element 116.

Otherwise, the fourth embodiment of an electrochemical device 100, which is illustrated in FIGS. 45 and 46, corresponds, as regards its structure, functioning and mode of manufacture, to the second embodiment illustrated in FIGS. 37 to 43, and in this respect reference is made to the description thereof above.

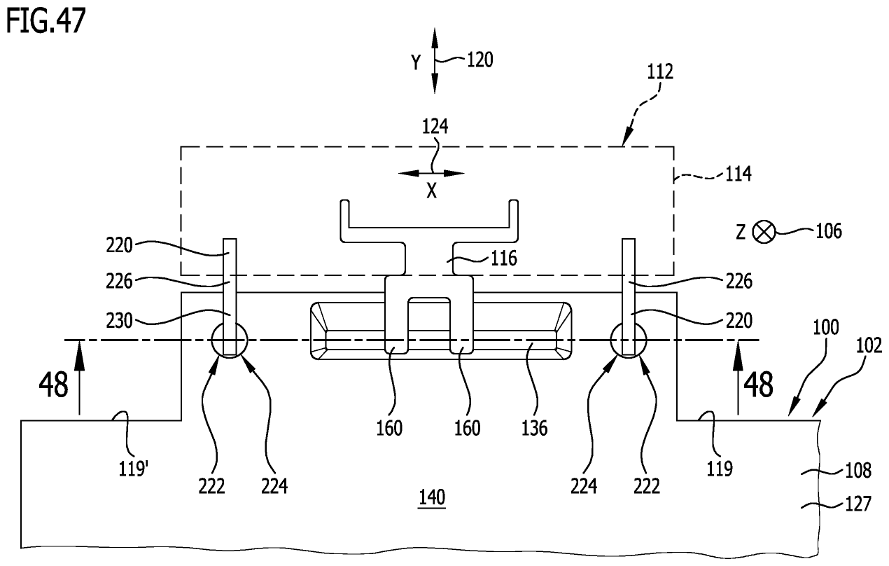

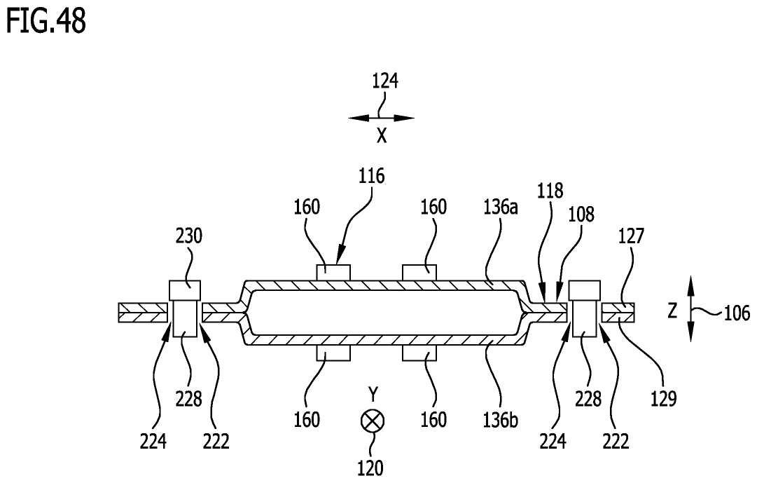

A fifth embodiment of an electrochemical device 100, illustrated in FIGS. 47 and 48, differs from the fourth embodiment illustrated in FIGS. 45 and 46 in that latching between the terminal connector 112 and the terminal elements 118 of the bipolar plates 108 is performed using one or more latch elements 220 which, in the mounted condition of the terminal connector 112, are latched in a respective latching recess 222 in the respective terminal element 118.

As can best be seen from FIG. 47, each latching recess 222 of this kind may take the form of a latching passage opening 224 that extends through the bipolar plate 108 in the region of the terminal element 118.

In the case of a multiple-layer bipolar plate 108, a latching passage opening 224 of this kind extends entirely through both the first bipolar plate layer 127 and also the second bipolar plate layer 129.

A latching recess 222 of this kind may in particular take the form of a substantially circular hole.

The diameter of a latching recess 222 of this kind may be for example more than 1 mm and/or less than 3 mm and may be for example approximately 2 mm.

The latching recesses 222 are preferably arranged on the terminal element 118 such that the contact-making beads 136a, 136b of the terminal element 118 lie between the latching recesses 222.

Each of the latch elements 220 may take the form of a latching arm 226 which is fixed to the housing 114 of the terminal connector 112 or is made in one piece with the housing 114 of the terminal connector 112.

A latching arm of this kind comprises a latching lug 228 which, in the mounted condition of the terminal connector 112, engages in the respectively associated latching recess 222, and a latching web 230 by way of which the latching lug 228 is connected to the housing 114 of the terminal connector 112.

Otherwise, the fifth embodiment of an electrochemical device 100, which is illustrated in FIGS. 47 and 48, corresponds, as regards its structure, functioning and mode of manufacture, to the fourth embodiment illustrated in FIGS. 45 and 46, and in this respect reference is made to the description thereof above.

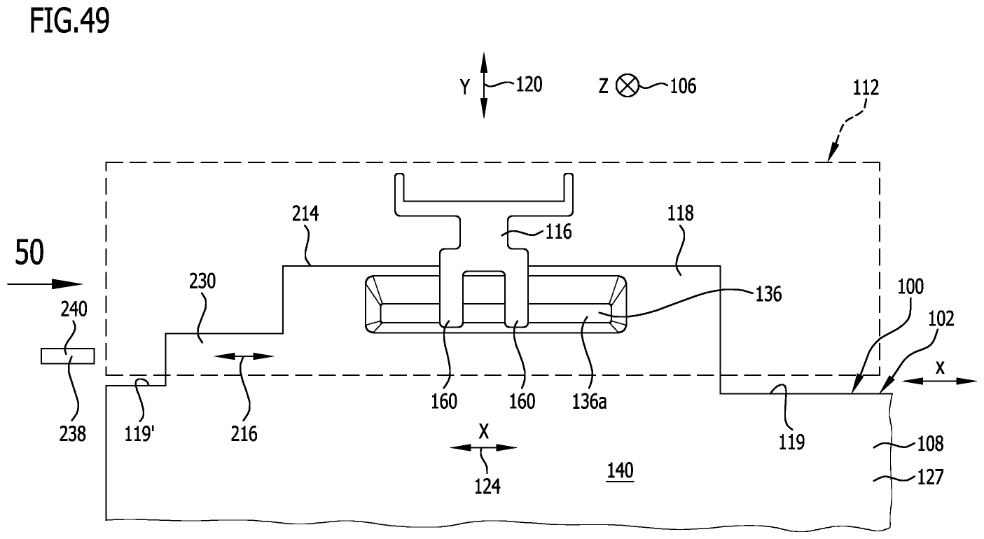

A sixth embodiment of an electrochemical device 100, illustrated in FIGS. 49 to 52, differs from the fourth embodiment illustrated in FIGS. 45 and 46 in the form taken by the latching mechanism by which, in the mounted condition, the terminal connector 112 is latched to the terminal elements 118 of the bipolar plates 108 of the stack 102 of electrochemical units 104.

In this embodiment, each of the terminal elements 118 comprises an immobilising projection 230, which projects from a lateral edge 218 of the respective terminal element 118 in the direction of offset 124 or X direction of the stack 102 of electrochemical units 104.

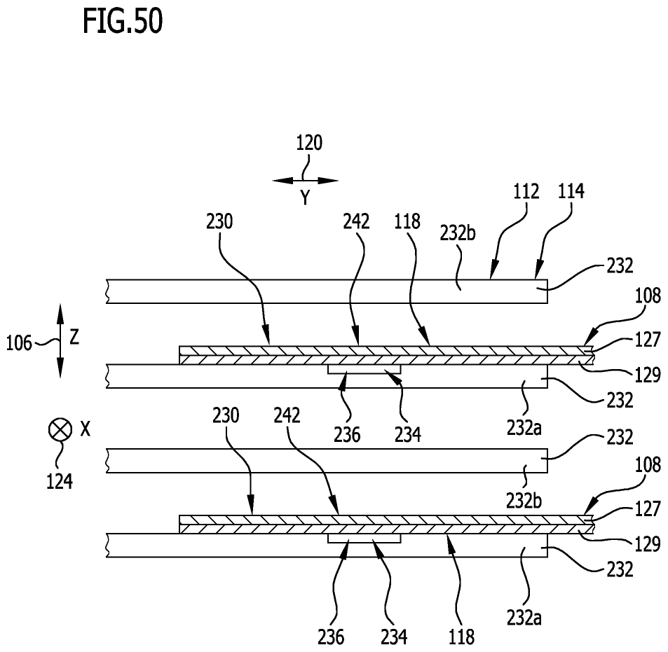

The immobilising projections 230 of each row 122 of terminal elements 118 are arranged one above the other in the stack direction 106 or Z direction of the stack 102 of electrochemical units 104 (see FIG. 50).

When the contact elements 116 of the terminal connector 112 are in engagement with the contact-making beads 136 of the terminal elements 118, the immobilising projections 230 of each terminal element 118 are arranged between two immobilising regions 232 of the housing 114 of the terminal connector 112, wherein, as seen in the stack direction 106, a first immobilising region 232a is arranged below the immobilising projection 230 and, as seen in the stack direction 106, a second immobilising region 232b is arranged above the immobilising projection 230.

One of the immobilising regions 232a, 232b, in the exemplary embodiment illustrated the first immobilising region 232a, has a deflection recess 234 which takes the form for example of a deflection groove 236 that extends parallel to the direction of offset 124 or X direction of the stack 102 of electrochemical units 104.

Further, in this embodiment the terminal connector 112 comprises, for each terminal element 118 and associated therewith, a respective immobilising element 238 that may for example take the form of a substantially cylindrical immobilising bolt 240.

In order to immobilise in position the terminal connector 112 that is arranged on the terminal elements 118 of the bipolar plates 108, the immobilising elements 238 are pushed in the direction of offset 124 or X direction of the stack 102 of electrochemical units 104, in each case between one of the immobilising regions 232, for example the second immobilising region 232b, of the housing 114 of the terminal connector 112, on the one hand, and an immobilising projection 230 of a terminal element 118 of a bipolar plate 108, on the other, as a result of which in each case a region 242 of the relevant terminal element 118 is displaceable into the deflection recess 234 in the respectively other immobilising region 232, for example the first immobilising region 232a, of the housing 114 of the terminal connector 112.

As a result, a positively-locking connection is produced between the immobilising projections 230 of the terminal elements 118, on the one hand, and the immobilising regions 232a of the housing 114 of the terminal connector 112 that are provided with the deflection recesses 234, on the other, as a result of which, in the mounted condition, the terminal connector 112 is immobilised on the bipolar plates 108 of the stack 102 of electrochemical units 104.

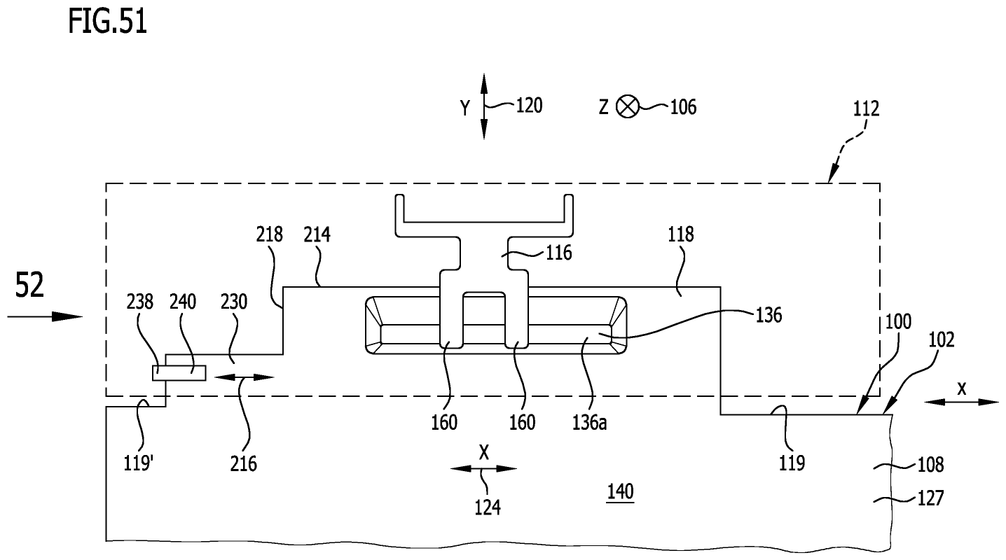

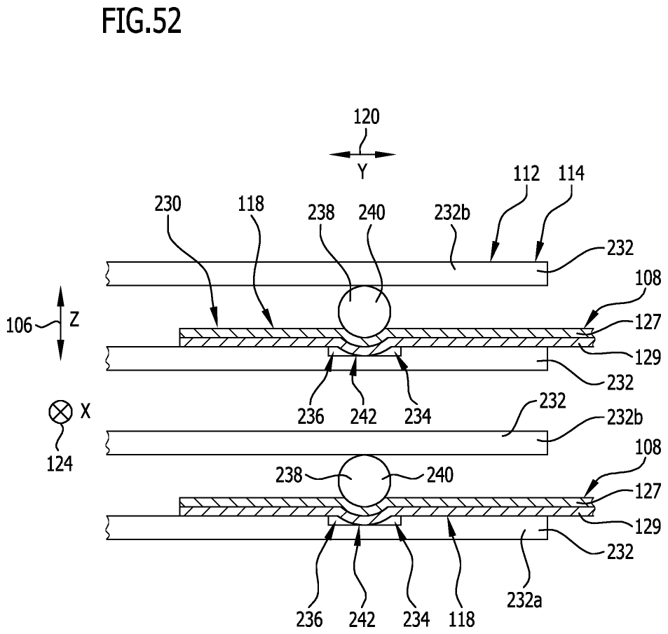

This immobilised condition is illustrated in FIGS. 51 and 52.

Otherwise, the sixth embodiment of an electrochemical device 100, which is illustrated in FIGS. 49 to 52, corresponds, as regards its structure, functioning and mode of manufacture, to the fourth embodiment illustrated in FIGS. 45 and 46, and in this respect reference is made to the description thereof above.

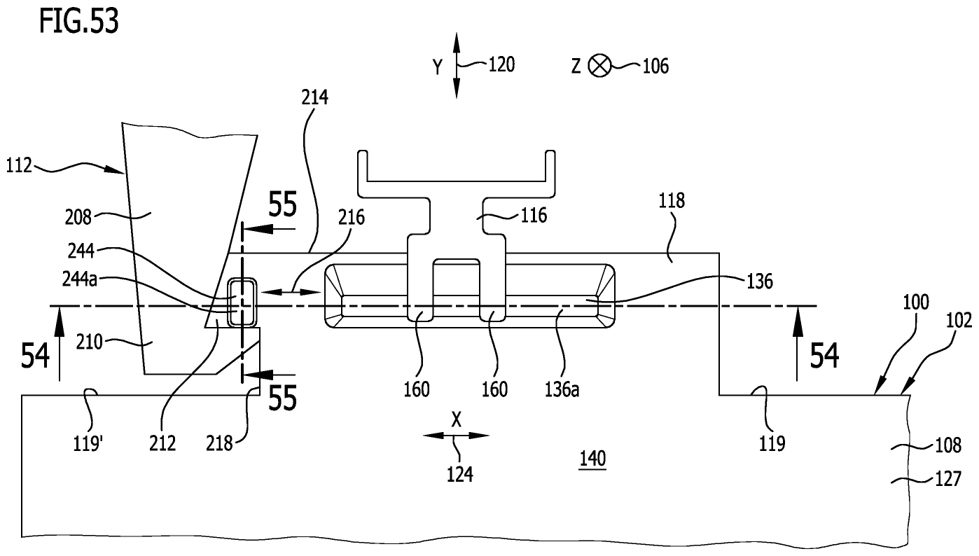

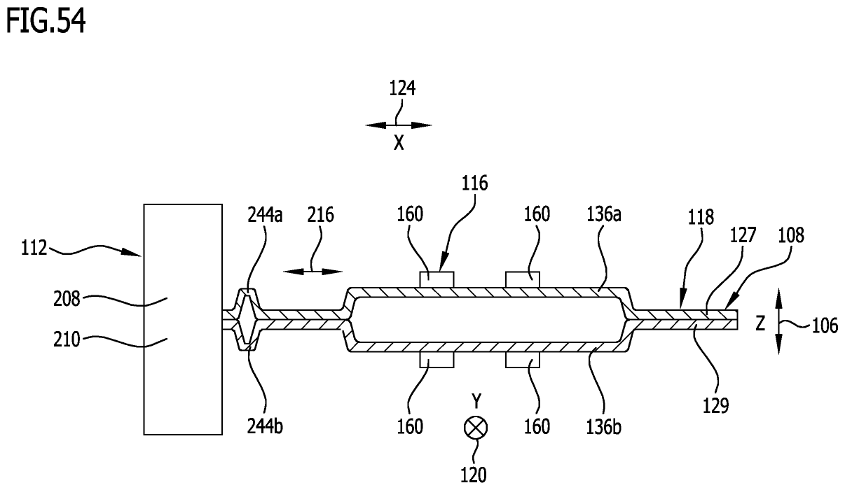

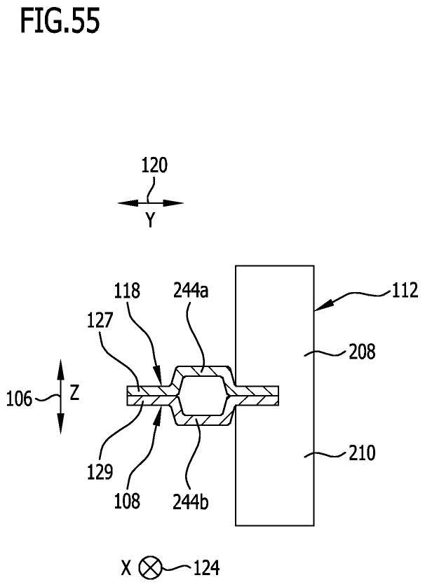

A seventh embodiment of an electrochemical device 100, illustrated in FIGS. 53 to 55, differs from the fourth embodiment illustrated in FIGS. 45 and 46 in that the latch element 208 of the terminal connector 112 does not engage at a rear edge of a latching projection 212 of a terminal element 118 but, in the mounted condition of the terminal connector 112, engages behind a latching bead 244 that is formed on the terminal element 118.

In this context, preferably a first latching bead 244a is formed in the first bipolar plate layer 127 and a second latching bead 244b is formed in the second bipolar plate layer 129.

Each latching bead 244 is preferably produced by shaping the respective bipolar plate layer 127, 129, for example by a stamping procedure or deep-drawing procedure.

Each latching bead 244 preferably extends in a longitudinal direction that is oriented substantially perpendicular to the longitudinal direction of the contact-making beads 136 of the terminal element 118 and/or perpendicular to the stack direction 106 of the stack 102 of electrochemical units.

Thus, each latching bead 244 preferably extends in the contact-making direction 120 or Y direction of the stack 102 of electrochemical units 104.

The first latching bead 244a and the second latching bead 244b may take a form substantially mirror-symmetrical to one another in respect of the centre plane 190 of the bipolar plate 108.

Otherwise, the seventh embodiment of an electrochemical device 100, which is illustrated in FIGS. 53 to 55, corresponds, as regards its structure, functioning and mode of manufacture, to the fourth embodiment illustrated in FIGS. 45 and 46, and in this respect reference is made to the description thereof above.

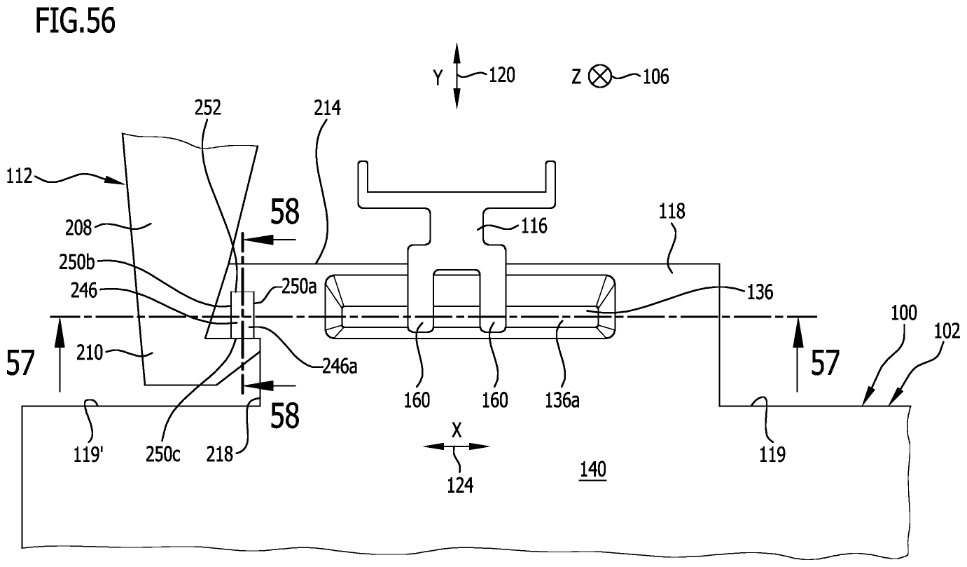

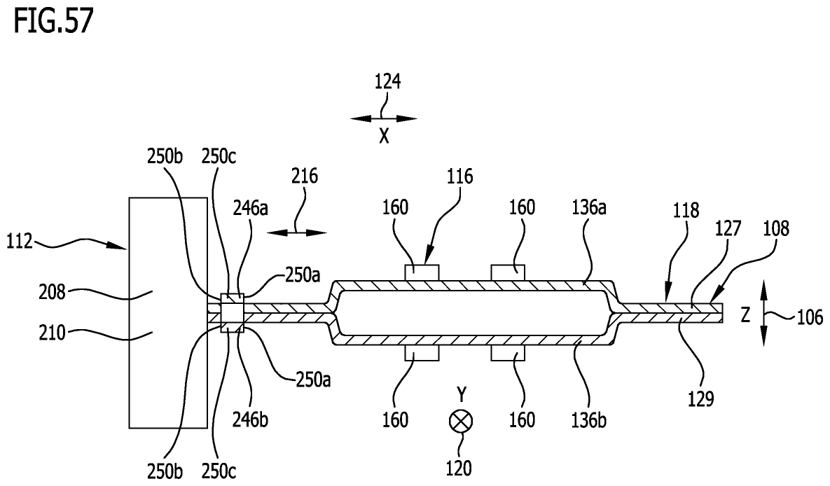

An eighth embodiment of an electrochemical device 100, illustrated in FIGS. 56 to 58, differs from the seventh embodiment illustrated in FIGS. 53 to 55 in that, in the mounted condition of the terminal connector 112, the latch element 208 of the terminal connector 112 does not engage behind a latching bead 244 formed on the terminal element 118 but instead behind a latching notch 246 formed on the terminal element 118.

In this context, preferably a first latching notch 246a is formed in the first bipolar plate layer 127 and a second latching notch 246b is formed in the second bipolar plate layer 129.

Each latching notch 246 is manufactured by severing the latching notch 246 from the respective bipolar plate layer 127 or 129 at a plurality of free edges 250, for example three free edges 250, for example by a stamping procedure or a cutting procedure, preferably a laser cutting procedure, and then bending or folding it out of the plane of the relevant bipolar plate layer 127 or 129, along a bend line 252.

Each latching notch 246 is thus connected in one piece with the respective bipolar plate layer 127 or 129 at the respective bend line 252.

The bend line 252 preferably runs parallel to the direction of offset 124 (X direction).

Two free edges 250a and 250b of the latching notch 246, each terminating at the bend line 252, preferably run substantially parallel to the contact-making direction 120 (Y direction).

A free edge 250c, which connects the two free edges 250a and 250b to one another, preferably runs substantially parallel to the bend line 252 of the latching notch 246 and/or substantially parallel to the direction of offset 124 (X direction).

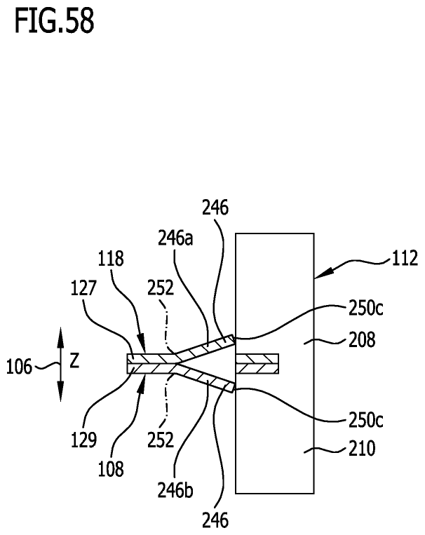

In the mounted condition of the terminal connector 112, the latch element 208 of the terminal connector 112 abuts against the free edges 250c of the latching notches 246a and 246b of the terminal element 118 (see FIG. 58).

Otherwise, the eighth embodiment of an electrochemical device 100, which is illustrated in FIGS. 56 to 58, corresponds, as regards its structure, functioning and mode of manufacture, to the seventh embodiment illustrated in FIGS. 53 to 55, and in this respect reference is made to the description thereof above.

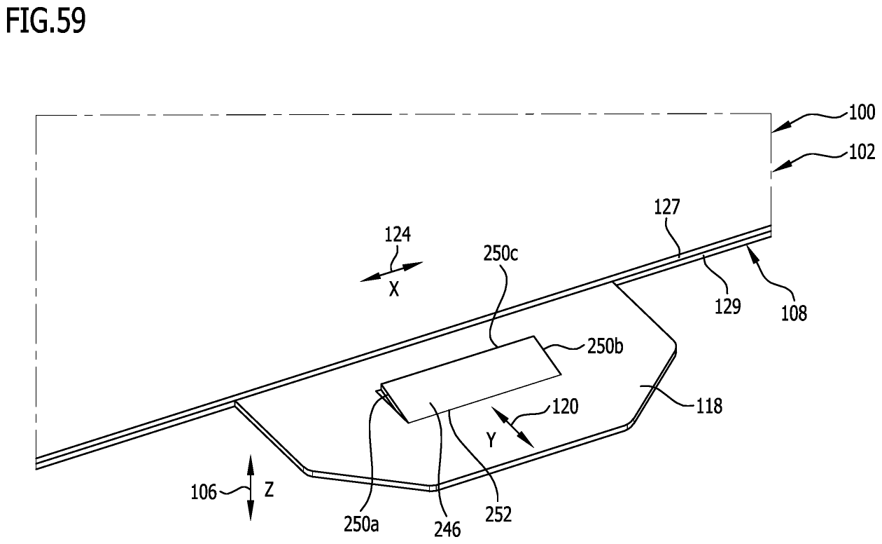

A ninth embodiment of an electrochemical device 100, illustrated in FIG. 59, differs from the first embodiment illustrated in FIGS. 1 to 36 in that the latching element 139 of the terminal element 118 takes the form not of a latching bead 141 but of a latching notch 246.

Further, in this embodiment the latching element 139 is only formed in one of the bipolar plate layers 127 and 129, for example the second bipolar plate layer 129.

The structure and mode of manufacture of a latching notch 246 of this kind have been described above in conjunction with the eighth embodiment of an electrochemical device 100, illustrated in FIGS. 56 to 58.

In this embodiment, the latching arm 152 of the contact element 116 associated with the terminal element 118 of the bipolar plate 108 of the stack 102 of electrochemical units 104 engages behind the latching notch 246 such that the latching tongue 154 of the latching arm 152 abuts against the free edge 250c of the latching notch 246.

Otherwise, the ninth embodiment of an electrochemical device 100, which is illustrated in FIG. 59, corresponds, as regards its structure, functioning and mode of manufacture, to the first embodiment illustrated in FIGS. 1 to 36, and in this respect reference is made to the description thereof above.

1. An electrochemical device, comprising a stack of electrochemical units that succeed one another in a stack direction,
wherein each electrochemical unit comprises a bipolar plate, and
a terminal connector that comprises an electrically insulating housing and a plurality of electrically conductive contact elements,
wherein a plurality of the bipolar plates each comprise a terminal element that projects in a contact-making direction, beyond lateral edges of the bipolar plate adjacent to the terminal element,
wherein the terminal element has at least one of
at least one latching element with which the terminal connector is latchable, and
at least one contact-making bead with which, in a mounted condition of the terminal connector, one of the contact elements of the terminal connector is engageable,
in order to make an electrically conductive contact between the bipolar plate and the respectively associated contact element of the terminal connector.

2. An electrochemical device according to claim 1, wherein the at least one contact element has at least two contact-making arms which, in the mounted condition of the terminal connector, abut against the terminal element.

3. An electrochemical device according to claim 2, wherein, in the mounted condition of the terminal connector, the two contact-making arms abut against two mutually remote sides of the terminal element.

4. An electrochemical device according to claim 1, wherein the at least one contact element has at least one latching arm that, in the mounted condition of the terminal connector, engages behind a latching element of the terminal element.

5. An electrochemical device according to claim 4, wherein the at least one contact element has at least two latching arms that, in the mounted condition of the terminal connector, abut against two mutually remote sides of the terminal element.

6. An electrochemical device according to claim 5, wherein one of the latching arms has a greater length than the other latching arm.

7. An electrochemical device according to claim 2, wherein the at least one contact element has at least one latching arm that, in the mounted condition of the terminal connector, engages behind a latching element of the terminal element and
wherein the at least two contact-making arms abut against a first side of the terminal element and the at least one latching arm abuts against a second side of the terminal element that is remote from the first side of the terminal element.

8. An electrochemical device according to claim 7, wherein the at least one latching arm of the contact element is arranged, as seen in a direction running parallel to the stack direction, between two contact-making arms of the contact element.

9. An electrochemical device according to claim 2, wherein the at least one contact element has at least one latching arm that, in the mounted condition of the terminal connector, engages behind a latching element of the terminal element and
wherein the contact element has at least two latching arms, wherein, in the mounted condition of the terminal connector, in each case a latching arm and a contact-making arm are arranged in pairs, one above the other in the stack direction.

10. An electrochemical device according to claim 1, wherein the terminal connector comprises at least one latch element which, in the mounted condition of the terminal connector, engages behind a latching projection of the terminal element.

11. An electrochemical device according to claim 1, wherein the terminal connector comprises at least one latch element which, in the mounted condition of the terminal connector, is latched into a latching recess in the terminal element.

12. An electrochemical device according to claim 1, wherein the terminal connector comprises at least one deflection recess and at least one immobilising element, wherein using this, in the mounted condition of the terminal connector, a region of the terminal element is displaceable into the deflection recess associated with the immobilising element.

13. An electrochemical device according to claim 12, wherein the at least one immobilising element is pushable into the housing of the terminal connector in a direction that is substantially parallel to a longitudinal extent of a latching element and/or a longitudinal direction of a contact-making bead.

14. An electrochemical device according to claim 1, wherein the terminal connector comprises at least one latch element which, in the mounted condition of the terminal connector, engages behind a latching bead formed on the terminal element, or a latching notch.

15. An electrochemical device according to claim 1, wherein the terminal connector comprises at least two rows of contact elements, each of which, in the mounted condition of the terminal connector, extend in the stack direction and are offset from one another perpendicular to the stack direction.

16. An electrochemical device according to claim 15, wherein, in the mounted condition of the terminal connector, each row of contact elements makes electrically conductive contact with every nth one of the bipolar plates that succeed one another in the stack direction, where n is greater than or equal to 2.
